(19) United States
(12) Patent Application Publication
(10) Pub. No.: US 2002/0022962 A1
(43) Pub. Date: Feb. 21, 2002

(54) Payment methods for on-line funeral home memorials

(75) Inventor: Kim L. Richardson, Kemah, TX (US)

Correspondence Address: Douglas H. Elliott, THOMASON, MOSER & PATTERSON, L.L.P., 3040 Post Oak Blvd., Suite 1500, Houston, TX, 77056, US

(73) Assignee: MARYBELLE, INC.

(21) Appl. No.: 09/751,662

(22) Filed: Dec. 29, 2000

Related U.S. Application Data
(63) Continuation-in-part of application No. 09/322,653, filed on May 28, 1999.

(51) Int. Cl. G06F 17/60

(52) U.S. Cl. 705/1

(57) ABSTRACT

A method of maintaining a memorial site on a funeral home web site, may include providing for the posting without charge of a memorial page on a funeral home web site, the memorial page corresponding to a deceased individual, the memorial page including a photograph of the deceased individual and identifying text; and providing for a payment option symbol on the memorial page or on a different web page linked to the memorial page, such that the payment option symbol can be activated to provide one or more payments for maintaining the memorial page.

### PRIOR RELATED APPLICATIONS

This application is a continuation-in-part of co-pending application, Ser. No. 09/322,653, filed May 28, 1999, and this application claims the benefit of such prior co-pending application.

### BACKGROUND

A. Field of the Invention

This invention is directed to the field of funeral home websites and more particularly to website memorials that are accessible through the funeral home websites.

B. Related Art

Various website-accessible memorials for funeral homes have been developed. Some memorials are operated by independent Internet based memorial services, which have their own websites that are not part of the funeral home's website or associated with the funeral homes. These memorials typically contain information originating from the families of the deceased. The memorials also typically include obituaries, similar to obituaries that are published in the newspapers, summarizing and eulogizing the life of the deceased.

These memorials have various shortcomings. For example, they are often not edited properly or contain incorrect information, through either miscommunications between the funeral homes and memorial service provider or between the funeral homes and the families of the deceased. The memorials also sometimes have information that the families of the deceased would like to change later, after they provide the initial information to the funeral home. Current memorials are not geared to easily making these types of interactive changes after the initial publication of the obituary or memorial on the Internet. Oftentimes, once they are set up, the memorials are “static” and are difficult to change or edit except by submitting written changes to the memorial service provider and then waiting for those changes to be made by a webmaster. In addition, these memorials are deficient in how they input and transmit information to the server that controls the memorial. Generally, these memorials do not provide the family members (who are organizing and paying for the funeral) with direct control over the content of the memorial.

Furthermore, it has been discovered that the general public, including families of deceased individuals, are often reluctant to purchase on-line memorials, either because they are not familiar with the concept of on-line memorials or do not recognize the value and/or desirability of having an on-line memorial site dedicated to the memory of the deceased. Accordingly, it is often difficult for funeral homes to convince the families to purchase on-line memorials. Certain embodiments of the present invention address this problem, and include payment methods for maintaining the memorial sites.

### SUMMARY OF THE INVENTION

One or more embodiments of this invention are directed to a method of maintaining a memorial site on a funeral home web site, including: (a) providing for the posting without charge of a memorial page on a funeral home web site, the memorial page corresponding to a deceased individual, the memorial page including a photograph of the deceased individual and identifying text; (b) providing for a payment option symbol on the memorial page or on a different web page linked to the memorial page, such that the payment option symbol can be activated to provide one or more payments for maintaining the memorial page.

In a specific embodiment, the payment option symbol includes a hyperlink or a button directing the viewer to a payment page including one or more fields for inputting credit card information to provide payment for maintaining the memorial page.

In a specific embodiment, the payment option symbol is located on the memorial page and invites the viewer to pay to maintain the memorial page, e.g., as a tribute to the deceased individual or as a gift to the family of the deceased.

In another specific embodiment, the different web page linked to the memorial page may be a “guest register” page or a “condolences” page, by which a guest to the memorial page is able to (a) register his or her visit to the memorial page or transmit condolences to the family and (b) activate the payment option symbol.

In another specific embodiment, any of the methods described herein may additionally include receiving information relating to the deceased individual by facsimile and inputting some or all of the received information on the memorial page prior to posting the memorial page.

The received information may be transmitted by facsimile from the funeral home to an external location where the information is inputted and the memorial page is posted.

In yet another specific embodiment of this invention, as part of a method described herein, the funeral home may post the memorial page without charge. Alternatively, an outside entity may post the memorial page for the funeral home without charge.

In any one of the methods described herein, the “identifying text” may include the obituary of the deceased individual.

Preferably, a payment for maintaining the memorial page is made to an entity other than the funeral home. It has been discovered, surprisingly, that while funeral homes are interested in obtaining revenues associated with their services, they often either do not want to get involved in collecting payments from persons wishing to maintain on-line memorial sites or individual memorial pages, or do not have the capability for doing so. For example, most funeral homes (as of the filing of this patent application) simply do not have their own web sites or on-line capabilities.

Still another specific embodiment of this invention involves a method of maintaining a memorial site on a funeral home website, including: (a) preparing a memorial site corresponding to a deceased individual; (b) posting the memorial site for viewing on a funeral home website for a first predetermined time period; (c) transmitting a request for payment to extend posting of the memorial site for a second predetermined time period beyond the first predetermined time period; and (d) extending the posting of the memorial site for the second predetermined time period.

Also, a specific embodiment of the invention includes a method of maintaining a funeral home website, including: (a) posting a memorial site for on-line viewing on the funeral home website; (b) transmitting a request for payment after the memorial site is posted; (c) deactivating the memorial site in the event payment is not received; and (d) extending the posting of the memorial site in the event payment is received.

A further specific embodiment of the invention includes a method of maintaining a funeral home website, including: (a) posting a first memorial site corresponding to a deceased individual for on-line viewing of the first memorial site on the funeral home website; (b) transmitting a request for payment after the first memorial site is posted but not before the first memorial site is posted; (c) posting a second memorial site corresponding to the same deceased individual in the event the requested payment is received, wherein the second memorial site has either substantially the same or additional content as the first memorial site; and (d) deactivating the first memorial site in the event the requested payment is not received.

In the aforementioned method, the memorial site may be posted on the funeral home website for the first predetermined period of time at no charge to the family of the deceased individual.

Also, the memorial site posted on the funeral home website for the first predetermined period of time may include a narrative containing a personal history of the deceased individual and at least one photograph.

The narrative containing a personal history of the deceased individual is preferably more extensive than the personal history contained in that individual's newspaper obituary.

In a preferred embodiment, the memorial site posted on the funeral home website for the first predetermined period of time includes two or more photographs that include the deceased individual, as opposed to the traditional single photograph typically used in obituaries.

In the method described above, the request for payment may be transmitted via email. Preferably, the request for payment is transmitted via email to a user entering his or her name on the Guest Book. Alternatively, the request for payment may be transmitted via email to a user entering information using the Condolences field. In yet another alternative, the request for payment may be transmitted via email to a Family Member.

In any one or all of the methods described above, the memorial site may be deactivated after the predetermined time period in the absence of payment.

Any one or all of the methods described above may include the step of receiving payment. Preferably, payment is received electronically. For example, payment may be received by transmission of credit card information.

In any one or all of the methods described above, the memorial site may be deactivated after the first predetermined time period in the absence of payment, and data symbolic of the time remaining for the memorial site to be deactivated may be provided, e.g., by email transmission to the family, or by posting on the memorial page or one of the other pages on the memorial site.

The data symbolic of time remaining for the memorial site to be deactivated may include a number representing the days left before the memorial site is to be deactivated or a number representing the actual date the memorial site is to be deactivated.

The act of providing data symbolic of time remaining for the memorial site to be deactivated can be done automatically, e.g., by the use of a time clock or conventional program that includes a timing subroutine. The first predetermined time period can be set by the person programming the computer, e.g., at 30 days, 60 days, or 90 days.

### BRIEF DESCRIPTION OF THE DRAWINGS

FIG. 1 is a schematic chart reflecting the relationship among various parts of a specific embodiment of the invention.

FIG. 2 is a flow chart showing steps that can be followed to create an interactive on-line memorial site of this invention.

FIG. 3 shows a web page from which a funeral director can create, edit, or view an individual memorial site.

FIG. 4 shows a web page with a funeral director's template for inputting and storing personal information corresponding to a particular memorial site.

FIG. 5 shows a web page with a scroll box containing names corresponding to multiple memorial sites.

FIG. 6 shows a web page with a memorial creation/editing template.

FIG. 7 shows a web page with a publicly viewable memorial.

FIG. 8 shows a “Private Family Area” web page.

FIG. 9 shows a web page with a memorial editing template.

FIG. 10 shows an example of a memorial page with a hyperlink for a payment option.

FIG. 11 shows an example of a page with fields for payment by credit card.

FIG. 12 shows another example of a page with a hyperlink for a payment option.

FIG. 13 shows another example of a page with fields for payment by credit card.

### DETAILED DESCRIPTION OF INVENTION

A. Introduction and Definitions

The invention is defined according to the appended claims including their equivalents. The invention will now be described in greater detail below, including specific embodiments, versions and examples, but the invention is not limited to these embodiments, versions or examples, which are included to enable a person having ordinary skill in the art of designing funeral home websites to make and use the invention, when combined with available information and technology. Various terms as used herein are defined below.

The term “workstation” refers broadly to any inputting device capable of transmitting instructions or other data, and is preferably a computer (device with a microprocessor), but can also be a data transmitter without a microprocessor, such as WebTV. The workstation of this invention is preferably a personal computer in a network, but can also be a high-performance, single-user microcomputer or minicomputer used for graphics, CAD, CAE, simulation and scientific applications.

The term “web site” (or “website”) is used in its conventional broadest sense, is located on at least one web server, contains web pages and other files, and is online, preferably 24 hours a day. The website includes pages stored in the memory of a web server. As discussed herein, the website includes, but is not limited to, the “memorial site.” It is contemplated that a funeral home may have two different “websites,” each located on different web servers, one of the websites including the memorial site pages discussed herein, the other website not having memorial site pages, but being linked to the website having the memorial pages.

The term “web server” refers broadly to a computer in a network shared by multiple users, e.g., workstations. It includes both the hardware and application software that performs the service.

The “web server” preferably provides World Wide Web services on the Internet, and includes the hardware, operating system, web server software, TCP/IP protocols and the web site content (web pages). In a given context, the term “web server” may also refer to just the software that performs this service, which accepts requests from web browsers to download data, such as HTML pages and images. A web server can also execute related server-side scripts that automate functions such as searching databases. It can include a conventional computer server having software designed to carry out the functions described herein, e.g., Internet software. A “web server” can include a computer system dedicated only to the web server application, but it can also be equipped to run other applications. A single web site can have several dedicated web servers. It is contemplated that any server having the capability of administering and managing on-line services, particularly the “web sites” and “memorial sites” of this invention, will meet the definition of a “web server.” In certain specific embodiments, the web server is directly or indirectly connected to a “central workstation,” discussed below.

A “central workstation” (or “corporate workstation”) is preferably a “guest” computer in relation to the “host” web server (preferably also a computer). In this invention, the central workstation should be physically located at a funeral home, the primary location for setting up, creating and editing the memorial site pages, and can also be referred to as the “funeral home computer” or “funeral director's computer.” The central workstation may include any type of computer, workstation, or other data manipulation product such as a PalmPilot or WebTV. Data transmission between the web server and the central workstation is preferably via a telecommunications service coupled with or otherwise connected to an Internet Service Provider (ISP), which is any organization or entity that provides access to the Internet, including small ISPs who provide service via modem and ISDN or larger ISPs who additionally provide private line hookups (e.g., Ti). The ISP (also referred to as a web server host or web host) provides access to the web server that has a funeral home website, with the funeral home having its own domain name. The data transmission carrier can be, for example, a telephone line, or a TI or ADSL or cable modem. The central workstation is preferably a computer (either a stand-alone computer or a computer on a network) located in a place remote to the web server, and where multiple funeral homes are involved, there will typically be multiple central workstations, at least one at each funeral home. Each central workstation is preferably directly or indirectly connected to the web server via a modem, router, or Ti, so that the central workstation, having its own conventional on-line software, can engage in interactive data transmission with the web server. Preferably, with the present invention, the web server includes “server-side software” such that data on the web server can be edited from either the central workstation or a family workstation, without the central workstation or family workstation needing to have special editing software. Each central workstation preferably has a “main website” (also, “corporate web site”) associated with it. Preferably, in the context of the specific embodiments of this invention discussed below, the “main website” is the website of a funeral home. As discussed above, the funeral home “main” website is deemed to include the memorial site pages, although the funeral home may have a separate website that can be linked to the main website for purposes of carrying out this invention. As used herein, the term “family workstation,” (also, “offsite workstation” or “end-user workstation”) can be a computer also having hardware devices and software applications that provide Internet connectivity via an Internet Service Provider (ISP) so that the family workstation or offsite workstation can browse the main website including viewing the individual memorial sites. The family workstation or offsite workstation can be connected to a conventional Internet Service Provider (ISP) or on-line service, e.g., America Online (AOL). The term “family workstation,” however, broadly includes any workstation operated or owned by persons who are not necessarily family members of the deceased, and is merely intended to emphasize the preferred aspects of this invention, i.e., that a family member of the deceased will typically be the one taking advantage of the editing features of this invention. In a preferred embodiment, the critical distinction is that the family workstation is one that is located at a place that is remote to the central workstation, e.g., at the home of a family member.

The “memorial site” refers broadly to a webpage or group of webpages located on the “main website” (“corporate website”) containing a “memorial” for a particular individual, e.g., a deceased individual, such as an announcement (obituary). In a specific embodiment of this invention, the memorial site includes one or more of the pages described below that contain templates that can be accessed on-line and filled from a corporate workstation. Preferably, the memorial site includes “multiple memorial site pages,” which are pages that are not specific to any deceased individual or family, but which are used by the funeral director for creating and managing individual memorial sites. The “multiple memorial site pages” (the “first set of pages”) includes at least one “protected” page (e.g., a Director's Page) that can be accessed only using a confidential password, e.g., the funeral director's confidential password, which in turn provides editing access to one or more protected pages, e.g., unassigned template pages, for creating accounts and/or creating the individual memorial site.

In another specific embodiment, the memorial site also includes “individual memorial site pages,” assigned to a particular deceased individual. Preferably, some or all of those pages are accessible using a second confidential password, e.g., a family confidential password, giving the user (family members) editing access to one or more “protected” pages, e.g., assigned template pages, for editing the memorial, e.g., using a protected “Private Family Area” page. Besides the “protected” pages which can be edited only using a confidential password, the memorial site also includes pages that can be viewed by the general public, e.g., by browsing. An “individual memorial site” refers to an individual or personal memorial site associated with a particular main website, as contrasted with the funeral home's website (e.g., “main website”), or the “multiple memorial site pages” which are not specific to such individual. Thus, each main website will include one or more individual memorial sites, and preferably includes multiple individual memorial sites, so that a single funeral home can potentially have individual memorial sites for each of its funeral service clients. Both the main website and the individual memorial sites can preferably be accessed over the Internet, for editing purposes, by the central or “corporate” workstation, and certain pages in the memorial sites can be accessed by one or more family workstations.

The term “funeral director” as used herein refers to an individual who either owns or is employed by a funeral home, and who organizes the funeral for the family of the deceased, typically having the responsibility of writing the obituary and conducting or supervising the funeral itself.

The terms “family” and “family members” refer to the family of the deceased, who typically commissions and/or pays for the funeral, and interacts with the funeral director to carry out the funeral, and who also usually has the greatest interest in memorializing the deceased in writing (e.g., by an obituary), so that others can express grief. The family also typically has the greatest interest in expressing grief and maintaining a memory of the deceased.

A “page” as used herein, refers to either a web page or the portion of a website that can be displayed on the screen of a computer monitor. Each page displayed on a screen has visual information that is typically stored on a web server or in databases or other servers connected to the web server. A page can also refer to a document occupying more than a single screen display (e.g., when a computer's screen is too small to accommodate an entire “web page” as defined by the web server). A “page” is preferably an HTML document in the context of the World Wide Web, and in the context of virtual memory systems is a segment of the program that is transferred into memory. Each memorial site includes multiple pages. In this invention, each time a hyperlink on one page is “clicked” the user is preferably directed to a different page associated with that hyperlink.

An important aspect of this invention is the “password,” which as used herein refers to any data or text string that is capable of triggering a user's editing and/or viewing access to preselected pages as described below. The password can be actual alphabetical words or numeric codes or alphanumeric combinations, and preferably also includes (or has associated therewith) some type of account identification number or data that functions as user authentication, account validation or personal verification. In a preferred embodiment, the password is confidential. In another embodiment, the password is a data set uniquely associated with an individual, such as data derived from a person's voice or photograph or even a person's fingerprint or DNA. Hypothetical examples of confidential passwords arc “O9as54qz” (alphanumeric) or “hokey” (alphabetical), which a funeral director can input while in a particular web site. A specific embodiment of this invention involves two types of confidential passwords, each providing different levels of protected access to a particular main website, e.g., a funeral director password with one level of access and a family member password with a more limited level of access. But in a preferred embodiment, even the funeral director password does not provide access to more than one main website. Note that the “passwords” as used herein do not refer to any password that might be held by the webmaster or entity controlling the web server, i.e., applicable to all the websites on a web server.

The term “access” or “accessibility” generally refers to the ability to store data on and retrieve data from a disk or other peripheral device, i.e., for editing. In some instances, the term “viewing access” is used, meaning that editing access is not necessarily provided. A person needs “access” (or “editing access”) to edit pages on a website, e.g., pages within a memorial site. The term “edit” refers to the act of changing existing data, particularly template data that has been stored in server memory and can be changed from different workstations.

The term “browse” refers to the act of viewing the contents of a file, group of files, or web page. A “browser program” typically enables one to view data by scrolling through documents or databases. As used herein, the ability to “browse” does not necessarily include an ability to edit data, which requires “access” (“editing access”).

A “database” is used herein in a conventional sense, referring to a set of related files that is created and managed by a database management system. Such systems are capable of managing various types of data including text, images, sound and video. Database and file structures are determined by the particular software used. With this invention, for example, Microsoft Access, FoxPro, or SQL Server can be used to create databases. The databases used in this invention can include a variety of tables, such as the listings of all the names of deceased individuals located on a particular web server, or on a particular corporate web site. Other tables can include a list of all family members having editing access to a particular website or a particular memorial site, a list of family members and friends signing the guest book and a list of stories written in memory of the deceased.

The term “user” refers to any individual who interacts with the workstation at an application level, e.g., at a computer terminal, and who is capable of inputting data or clicking hyperlinks.

The terms “template” and “form” (used synonymously) both refer to the programmatic and descriptive part of a programmable application. Generally, when a template is filled with data, it becomes a working application. Preferably, as used herein, a template includes a formatted screen display designed for a particular application, e.g., the creation or editing of a memorial site. A template can be “blank” (except for default information) in which case it is deemed to be “unassigned.” Once data is inputted into the fields in the template (e.g., from a workstation) and entered, so that the template data is transmitted to and stored in web server memory, a new “filled” (or “assigned”) template is deemed to be created and stored in memory, e.g., in the web server. As used herein, the terms “assigned template” and “filled template” (including partially filled templates) refer to the template itself, which is a formatted screen display, generally stored in the web server in read-only memory, and the inputted data, which is stored in the web server memory (usually in a database) and which can be accessed and edited. When an assigned or filled template is accessed from a workstation, the template application software connected to or on the web server generates a screen display, which is preferably transmitted to the workstation, showing the template “populated” with the stored data. Thus, each template is typically an interface that a user can use (e.g., from a workstation) to enter data (i.e., populate the template). The data that is entered is then generally stored in some form of a database. The data corresponding to each fully populated template can be stored in a database record. The database record typically has an identifier that is used to call the record when somebody wants to view a populated template. The term “populated template” is also referred to-herein from time to time as a “filled” template or an “assigned” template. It is contemplated that commercially available forms software can be used for the templates of this invention, including workflow software which can be used to create on-screen data entry forms and provide e-mail routing and tracking of the resulting electronic documents. Forms software can also include program development tools that build applications by designing the on screen forms for data entry, updates and so on. Such forms are generally designed with visual programming tools that allow fields, buttons and logos to be drawn directly on screen. The logic can be selected, for example, via menus and/or written behind each field or button with lines of 4GL or 3GL. programming code. FrontPage, by Microsoft, and ASP-db Enterprise, by Major Micro Systems, can be used to create the templates (forms) of this invention. Other template programs include MS in MS Visual InterDev (by Microsoft) and Cold Fusion, by Allaire Company.

The term “hyperlink” is used herein in its conventional sense, preferably referring to a predefined linkage between one object and another. A hyperlink can be displayed on the page as either text or an icon (symbol) or underlining or shading. The term “hyperlink” is used herein in its broadest sense, and allows, for example, a user to move from a first page (that is on the screen at the time) to another preselected second page, document or location, preferably one that is on the same web site, by “clicking” on some word or icon (symbol) on the first page. Typically, an alternative (but usually more time-consuming) method of moving to the second page, document or location is by inputting the underlying URL defined by hyperlink format (e.g., by blinking or underlining or color). The “URL” is a Uniform Resource Locater which is an address that defines the route to a file on the web or any other Internet facility.

Preferably, the document format used with the present invention is HyperText Markup Language or “HTML,” which is the document format used on the World Wide Web. Web pages can be built with HTML tags or codes embedded in the text. HTML defines the page layout, fonts and graphic elements as well as the hypertext links (“hyperlinks”) to other documents on the web. Each link contains the URL, or address, or a web page residing on the same server or any server worldwide. HTML 2.0 has a basic set of features including interactive forms capability. Subsequent versions have added more features such as blinking text, custom backgrounds and tables of contents. Each version requires agreement on the tags (codes) used and browsers are modified to implement those tags. HTML is a “presentation language,” and is not full-blown programming language such as Java or JavaScript.

A “guest” refers to a person who logs into a network or service but who does not have a user account or password. In certain specific embodiments of the invention herein, a “guest” might be any member of the public or a non-family member interested in attending the funeral of the deceased or reading the obituary. “Guests” are given a default set of “privileges,” which may include limited viewing access (browsing, but not editing) to certain memorial site pages. In a preferred embodiment of this invention, the “guests” do not have editing access to either the Director's Page (reserved for the funeral director) or certain other pages or templates (reserved for the family members). The family members are not considered “guests” within the context of this invention.

B. Payment Methods

As discussed above, one or more specific embodiments of this invention are directed to a method of maintaining a memorial site on a funeral home web site. In one aspect, the method may include providing for the posting without charge of a memorial page on a funeral home web site. The act of providing for the posting of the memorial page can refer to the initial placement of the memorial page on a web page, e.g., such that the memorial page can be viewed on-line from a remote location, e.g., using the Internet. This form of posting may be referred to as the “initial posting.” The act of providing for posting can also include directing another to place the memorial page on a website so that it is viewable. Further, the act of providing for posting can also include other actions that result in maintaining the memorial page in a posted condition, and, for example, may include extending the posting of the memorial page. The term “posting” is thus intended to have a broad meaning and should not be construed any more narrowly than other forms of posting web pages or information on web pages unrelated to memorials, e.g., advertising. Also, the memorial page should correspond to a deceased individual, and should include a photograph of the deceased individual and identifying text. The term “identifying text” means that the text (which is verbal) makes a direct or indirect reference to the deceased individual.

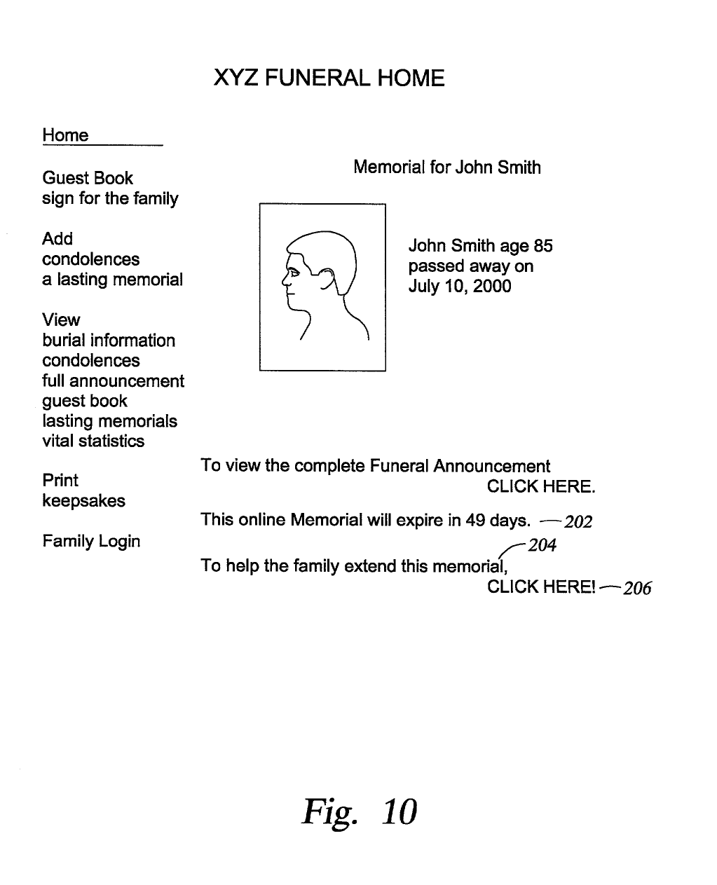

One aspect of this invention includes the providing for a “payment option symbol.” In a specific embodiment, the payment option symbol includes a hyperlink or a button directing the viewer to a payment page including one or more fields for inputting credit card information to provide payment for maintaining the memorial page. The payment option symbol is preferably located on the memorial page, but may also be located on a different web page linked (directly or indirectly) to the memorial page, such that the payment option symbol can be activated to provide one or more payments for maintaining the memorial page. This payment option symbol preferably includes verbal text or symbols, e.g., a string of words, a phrase, or a sentence that communicates the payment function. However, the payment option symbol need not include the word “payment” or its equivalent, however, but may instead refer to the result of the payment, e.g., “click here to extend the memorial,” or “click here to maintain this tribute.” Although not preferred, the payment option symbol may be a phrase that does not necessarily suggest payment at all, but nevertheless, when activated, causes a different web page or different part of the same web page to appear. For example, the payment option symbol may be an innocuous statement such as “for more information, click here.” Also, while certainly not preferred, certain operators of this invention might have a payment option symbol that is somewhat misleading, e.g., in that it could include a statement that is literally true, but does not convey the existence of a payment option to the viewer. Further, the payment option symbol may be nonverbal, e.g., an arrow or a heart. Also, in at least one specific embodiment, the payment option symbol includes the actual fields for transmitting payment, e.g., one or more fields for inputting credit card information or the equivalent. When the payment option symbol is either nonverbal or includes an innocuous statement, there should be some text external to the payment option symbol that explains the function of the payment option symbol. For example, in FIG. 10, the payment option symbol is the phrase “click here,” which activates a hyperlink, but that payment option symbol is preceded by the phrase, “To help the family extend this memorial, ” In any event, it is preferred that the payment option symbol, either alone or with the assistance of explanatory language, clearly communicate to the viewer either that activation of the symbol causes the appearance of a different web page that includes more details regarding payment, or that activation of the symbol causes the appearance of a different web page that includes details regarding how to continue or extent the posting of, or to maintain, the memorial page, which can include a variation of the memorial page that is initially posted or in existence at the time the payment option symbol is activated.

In a specific embodiment, the payment option symbol is located on the memorial page and invites the viewer to pay to maintain the memorial page, e.g., as a tribute to the deceased individual or as a gift to the family of the deceased. Note that the payment option symbol may also be located on a different page, e.g., the “condolences” or “guest book” pages (terms that are routinely used in the website memorial site industry). However, It is considered desirable for the payment option symbol to be on the first page of the memorial site, e.g., proximate the photograph or name of the deceased or proximate the obituary or other announcement. The reason for this desirability is that one of the goals of at least certain specific embodiments of the invention that include a payment option symbol is for viewers, who may not be family members, to cause payment. Such viewers may only look at the first (and in some cases the only) page of the memorial site, e.g., the memorial page. For purposes both of causing the maintaining of the memorial page and of generating revenues for the funeral home or operator of the system that maintains and displays the memorial page, it is desirable for the maximum number of individuals to be aware of the ability to effect payment, e.g., as a tribute to the deceased individual or as a gift to the bereaved family. It is contemplated by the inventor that this maximum number is best achieved by placing the payment option symbol on the memorial page, which will be seen by the maximum number of persons. Note that the payment option symbol may even be located on the funeral home's home page, or some other web page that is not uniquely associated with the deceased individual. However, this other web page will be directly or indirectly linked to the memorial page.

As discussed above, any of the methods described herein may additionally include receiving information relating to the deceased individual by facsimile and inputting some or all of the received information on the memorial page prior to posting the memorial page. It has been discovered, at the time of this invention, that funeral home directors often do not wish to perform the acts of inputting information that will be placed on the memorial page. These funeral home directors may commission, hire, or contract with outside entities (companies or individuals) who actually place the information on the appropriate web pages, e.g., inputting the obituary or funeral announcement onto the web page, and/or scanning one or more photographs corresponding to the deceased individual onto the web page.

Thus, in a specific embodiment, the method may include receiving information relating to the deceased individual by facsimile. For example, during a visit with the family members, a funeral director may type up or otherwise generate an obituary or other announcement relating to the deceased individual, e.g., using a word processor, then cause the obituary or announcement to be printed out on paper, then fax to a different location the printed obituary or announcement to individuals who then cause that information to be inputted into a memorial page. It is contemplated that the utilization of facsimile transmissions to operators of the memorial site not only offers convenience to the funeral directors, but also is an attractive feature to funeral directors who are not comfortable using computers or the Internet. The received information may be transmitted by facsimile from the funeral home to an external location where the information is inputted and the memorial page can be posted.

Alternatively, the act of receiving information may include receiving information by email or through some other form of data transmission, including voice transmission. For example, in the case of voice transmission, voice activated software may be utilized to receive the dictation of the information relating to deceased individual over the telephone. Software packages for implementing voice-activated dictation are known and may be used in this context. For example, a funeral director may dial a telephone number that places him in telephone/voice contact with the operator of the memorial site, and reads out the obituary or other announcement over the telephone. The voice-activated software on the other end of the line converts the transmitted words to text that is inputted into and/or is made to appear on the memorial page.

In yet another specific embodiment of this invention, as part of a method described herein, the funeral home may post the memorial page without charge. Alternatively, an outside entity may post the memorial page for the funeral home without charge. The term “charge” as used herein includes any act that creates an obligation on the part of at least the family members to pay for the posting of the memorial page, including the obligation to pay for extending the posting of the memorial page. Thus, the term “without charge” refers to the absence of such obligation.

In any one of the methods described herein, the “identifying text” may include the obituary of the deceased individual, but may also merely be a short description of the individual, e.g., the name. Preferably, however, the identifying text constitutes the entire obituary, preferably the same obituary that appears in the newspaper.

Another feature of one or more specific embodiments of this invention is the “payment” feature. Although payment for maintaining the memorial page can be made to the funeral home directly, it is preferred that such payment be made to an entity other than the funeral home. It has been discovered, surprisingly, that while funeral homes are interested in obtaining revenues associated with their services, they often either do not want to get involved in collecting payments from persons wishing to maintain on-line memorial sites or individual memorial pages, or do not have the capability for doing so. For example, most funeral homes (as of the filing of this patent application) simply do not have their own web sites or on-line capabilities. Thus, it is considered to be more convenient for the payment logistics be handled by an entity other than the funeral home.

Another specific embodiment of this invention involves a method of maintaining a memorial site on a funeral home website, wherein the method includes: (a) preparing a memorial site corresponding to a deceased individual; (b) posting the memorial site for viewing on a funeral home website for a first predetermined time period; (c) receiving a request for payment to extend posting of the memorial site for a second predetermined time period beyond the first predetermined time period; and (d) extending the posting of the memorial site for the second predetermined time period.

The act of preparing and posting a memorial site corresponding to a deceased individual is understood to cover a variety of known methods for preparing memorial sites, and it is understood that any conventional software, useful for preparing other types of web pages, may be utilized. For example, a number of known, commercially available software packages enable one to prepare the memorial site. The posting of the memorial site preferably provides for online viewing of the memorial site from remote locations, i.e., from locations that are separated from both the funeral home and the web server, e.g., using the Internet and the World Wide Web. For example, a person who uses America Online's Internet service, or any one of Microsoft's services (e.g., MSN) should be able to view the memorial site, preferably by first going to the funeral home's web site, then activating a hyperlink to move to the memorial site portion of the funeral home's web site or a web site that is linked to the funeral home's web site. In the embodiment described above (and other specific embodiments described herein), the memorial site is posted for a “first predetermined time period.” This means that the memorial site should not be activated for an indefinite or perpetual period of time. The software that supports or controls the memorial site preferably includes instructions that cause the memorial site to become deactivated (e.g., no longer viewable on-line) after a predetermined period of time. In a less preferred embodiment, the predetermined period of time is not actually programmed into the software, but rather is predetermined by an operator, who may manually “shut down” the memorial site after a set period of time. The purpose of this feature is to encourage payment for the ongoing posting of the memorial site, which can be accomplished by causing the memorial site to become deactivated upon non-payment. However, because the family members or other viewers often do not appreciate the value of the memorial site until they actually see it, there is a contemplated benefit to having the memorial site activated for “free” so long as a decision is eventually made to provide some compensation for the creation, posting and maintenance of the memorial site. Preferably, the first predetermined time period is 30, 60, or 90 days, although shorter time periods are also contemplated, e.g., 10 days or one week.

The act of transmitting a request for payment to extend posting of the memorial site for a second predetermined time period beyond the first predetermined time period is an important feature of this particular embodiment. Preferably, the request for payment is transmitted using a payment option symbol, discussed above. However, the request for payment may be accomplished in other ways. For example, an email message requesting payment may be transmitted to persons who have identified themselves in some way in the context of the memorial site, e.g., by registering in the Guest Book, or by typing in condolences. Also, before the memorial site is deactivated, it is desirable to transmit a request for payment to the family members, e.g., if no one else has volunteered to make a payment to maintain the posting of the memorial site. In a preferred embodiment, the request for payment includes or is associated with a message indicating when the predetermined time period will expire, and the memorial site will be deactivated, and also indicating that the time period can be extended based on some action by the viewer, that will ultimately require payment. For example, the message may state: “This memorial site will be deactivated on [date].” If you would like to help the family maintain this memorial site, click here.” Or the message may state: “This memorial site will be deactivated in X days. If you would like to help the family maintain this memorial site, click here.”

In this specific embodiment, the method also includes extending the posting of the memorial site for the second predetermined time period. Preferably, the second predetermined time period is longer that the first predetermined time period. For example, the second predetermined time period is preferably at least in yearly increments, e.g., one year from the date of payment, whereas the first predetermined time period is preferably in monthly increments. In a specific embodiment, the second predetermined time period is perpetual, limited only by whether the website is in existence. Preferably, the amount of time corresponding to the second predetermined time period is proportional to the amount of the payment. For example, a two-year extension will cost more than a one-year extension. Also, the extending of the posting for the second predetermined time period preferably requires a payment.

As discussed above, another specific embodiment of the invention includes a method of maintaining a funeral home website that includes (a) posting a memorial site for on-line viewing on the funeral home website; (b) transmitting a request for payment after the memorial site is posted; (c) deactivating the memorial site in the event payment is not received; and (d) extending the posting of the memorial site in the event payment is received. In this specific embodiment, the method includes the affirmative step of deactivating the memorial site when payment is not received, preferably within a predetermined time period. In this embodiment, the critical decision is the determination that payment is either “not received” or “received.” A number of ways exist to make this decision, but it is preferable that the determination is made at a predetermined time, as discussed above. However, in at least one specific embodiment, one performing this method may decide to make this decision at a predetermined date, e.g., at the end of each calendar year, or after speaking with family members or others to determine whether they wish to make a payment to maintain the memorial site. In different specific embodiments, the “default” condition may be to either maintain the memorial site, with the hope or expectation that payment will eventually be made, or to deactivate the memorial site in the absence of payment within a predetermined period of time.

As discussed above, a method of maintaining a funeral home website may include: (a) posting a first memorial site corresponding to a deceased individual for on-line viewing of the first memorial site on the funeral home website; (b) transmitting a request for payment after the first memorial site is posted but not before the first memorial site is posted; (c) posting a second memorial site corresponding to the same deceased individual in the event the requested payment is received, wherein the second memorial site has either substantially the same or additional content as the first memorial site; and (d) deactivating the first memorial site in the event the requested payment is not received. In this specific embodiment, two different memorial sites may be involved. Here, it is recognized that a request for payment is often not effective unless the potential payor is able to see a sample of what they would be paying for. Thus, with this method it is desirable that no payment request be made until after a first memorial site is initially posted. In the event payment is made by the payor and received by the payee, a second memorial site will then be posted. With this embodiment, the first memorial site is an abbreviated memorial site, which should include at least a photograph and a basic announcement, e.g., the language of the newspaper obituary. That is, the memorial site posted on the funeral home website for the first predetermined period of time should include a narrative containing a personal history of the deceased individual and at least one photograph. Depending on the amount of the payment, a second memorial site can be created that is more extensive than the first memorial site. For example, a complete personal history can be included. Also, a more extensive collection of photographs can be included, such as a complete “photo album” that includes photographs stimulating memories of the deceased individual, accomplishments, newspaper headlines and articles the provide an historical context to the individual's life, all intended to serve as a tribute to the life that the individual has lived and that person's contributions to this world. However, it is recognized that because a great deal of effort is potentially involved with creating this second memorial, different levels of payment should be involved. It is also contemplated, with this specific embodiment (and others) that the viewer may be given the opportunity to purchase on-line software that enables them to create the second memorial site themselves. A number of “photo album” or “personal history” software packages are known and commercially available for this purpose.

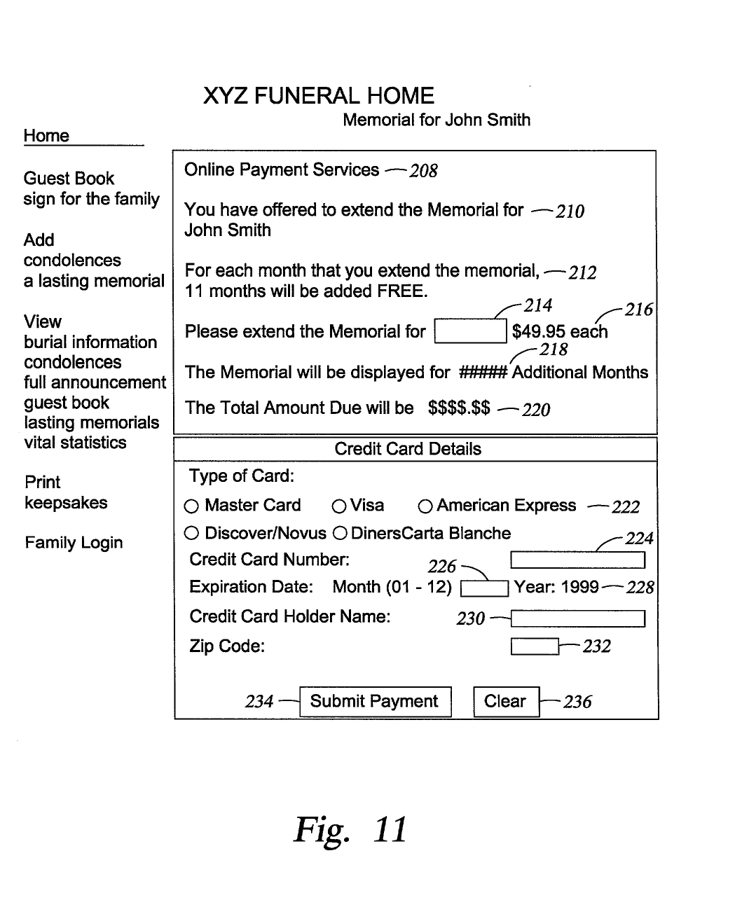

In any of the methods described above, the request for payment may be transmitted via email, or by any other conventional means, including fax or telephone. One contemplated way of requesting payment, defined herein as a “manual” or “non-electronic” request for payment,” involves communicating with the Family or other payor by telephone or conventional mail, and requesting payment orally or in writing. However, a preferred way to execute a request for payment is electronically. One type of electronic request for payment is email, e.g., electronic mail using any commercial service, such as MSN or America Online (AOL). Thus, an electronic request for payment may be transmitted via email to a user who enters his or her name on the Guest Book. Alternatively, the request for payment may be transmitted via email to a user who enters information using the Condolences field. In yet another alternative, the request for payment may be transmitted via email to a Family Member. As yet another alternative, an electronic request for payment, different from “email,” may be executed by any action that includes placing a request for payment on one of the web pages discussed herein that are associated with the memorial page, e.g., anywhere on the memorial site. For example, the web page shown in FIG. 11 includes a request for payment 220 of the “Total Amount Due.” This request for payment is made by the entity that operates or controls the web site, and is made to the individual that will be making the payment, e.g., authorizing the payment by credit card. Note that in the cases described above, the individual or entity performing the action that is considered to be a request for payment is an individual or entity that is either actually receiving the payment, or authorized by the one receiving the payment to make the request. In a preferred embodiment of this method, the individual or entity making the request for payment is either the funeral home director or some person or company that operates the memorial site who is authorized to do so by the funeral home director.

Any one or all of the methods described above may include the step of receiving payment. One contemplated way to receive payment is to receive a check or cash that accomplishes or completes the payment. In a preferred embodiment, however, payment is received electronically. For example, payment may be received by transmission of credit card information, which preferably includes authorization to receive transfer of funds from a payor's account, e.g., a credit card holder's credit card account. As used herein, the act of “receiving payment” is defined to include receiving credit card (or debit card) information. Of course, a variety of known methods for receiving payment are available, including wire transfer methods and all known methods of transferring funds.

A number of software packages, software “suites” and software programs that enable one to include or link to a web page that effects electronic payment, e.g., by credit card or other form of payment (transfer of funds) are available to and known by persons skilled in the art of designing and constructing commercial web sites that involve payment transactions. Many of these commercially available software programs can be used in any of the methods described herein. For example, a number of software packages enable the creation of a “shopping cart,” which can be used to create a page for purchasing items, e.g., a memorial site. The operator of the funeral home web site or memorial site can include one of these shopping cart pages on his web site server or cause his web site server to be linked to another server containing the shopping cart pages. Credit card or other payment information may be transmitted electronically using one or more different pages. One example of a “shopping cart” is a software program called “StoreFront,” available by accessing the web site at Storefront.net, currently owned by LaGarde, in Lawrence, Kans.

Other programs can be used to cause payment by causing the transfer of funds, e.g., by causing the processing of credit card information, which authorizes a credit card company to pay funds to the funeral home or memorial site operator on behalf of a credit card holder. A variety of commercially available software programs can be used to process on-line credit card purchases, to effect payment (transfer of funds). One such program, available by accessing the web site at Authorize.net, located in Provo, Utah, is called “Virtual Terminal.” Another program, called CashRegister, is available from CyberCash, Inc., located in Reston, Va. Memorial pages, such as those disclosed herein, may include hyperlinks to effect credit card payments. For example, a funeral home web site can include a page that collects credit card information and transfers that information to an entity that processes the transaction, e.g., Virtual Terminal or CashRegister. Thus, a funeral home web site can include a page that has a hyperlink that transfers the user to the linked web site such as those supported by Virtual Terminal or CashRegister programs.

An example of a memorial page illustrating certain features of a number of specific embodiments of this invention is shown in FIG. 10. That memorial page can form part of a memorial site which can form part of a larger funeral home web site. The memorial page in FIG. 10 includes the statement 202 “This online Memorial will expire in 49 days,” which indicates when the memorial site will be deactivated, as discussed above and elsewhere herein. The page also includes the phrase 204 “To help the family extend this memorial,” along with the phrase 206 “Click here!” The phrase 206 is connected to a hyperlink, and is activated by clicking the mouse with the cursor on the phrase 206, causing a different web page to be accessed, e.g., the web page shown in FIG. 11. The phrase 204 is an example of how a request for payment can be initiated. The phrase 204 explains the purpose of the phrase 206, and indicates that the phrase 206 is what must be clicked to activate the hyperlink. The phrase 206 is an example of a payment option symbol.

An example of two different pages that contain information for effecting payment is shown in FIG. 11. The first page is found in the upper portion of FIG. 11 and the second page is found in the lower portion of FIG. 11. The actual pages were combined to form FIG. 11 for illustrative purposes, although it is not outside the scope of the invention to include all the information shown in FIG. 11 on a single actual web page. Each of the pages in FIG. 11 includes a number of fields that are (a) filled in by the user, e.g., an individual wishing to purchase a memorial site, then (b) transmitted to a receiver of the information, e.g., the operator of the web site, who may be the funeral home itself or some entity performing memorial site services for the funeral home. The phrase “Online Payment Services” 208 indicates the purpose of the information being provided, i.e., that payment is to be effected by providing credit card information which will be transmitted on-line. The phrase “You have offered to extend the Memorial for [name of deceased individual]” 210 indicates both the name of the deceased individual whose memorial is being extended and the agreement to extend the Memorial. Explanatory text 212 states the terms of the agreement, e.g., “For each month that you extend the memorial, 11 months will be added FREE,” and identifies the extended period of time the memorial is posted in return for the payment. The blank field 216 identified by the phrase “Please extend the Memorial for” is to be filled in by the payor, e.g., the Family Member or a friend of the Family wishing to effect a payment to maintain a memorial page for the Family. Field 216 reflects the dollar amount of the payment. The software is programmed to automatically generate the number 218 of “additional months” that, when combined with the paid month, equals the total extended period of time the memorial site is to be posted or maintained. The phrase “The Total Amount Due will be” explains the dollar amount 220 which is also automatically generated by the software, indicating the total amount of the payment.

The second page in FIG. 11 includes additional payment-related fields which supply credit card information. Fields 222 are filled in to identify which credit card is to be used. The account number of the credit card is inputted in Field 224, along with the expiration date in fields 226 (month) and 228 (year). Then the name of the credit card holder is inputted in field 230 along with that person's zip code in field 232. At the bottom of the page is button 234, which submits the information to the credit card processing entity, e.g., Authorize.net or CyberCash. Alternatively, the submit button 234 may be configured to send an email to the memorial site operator or funeral home director who can process the credit card information manually. Button 236 may be activated if all the fields are to be cleared, e.g., if the information is incorrect, or if the person does not wish to complete the transaction.

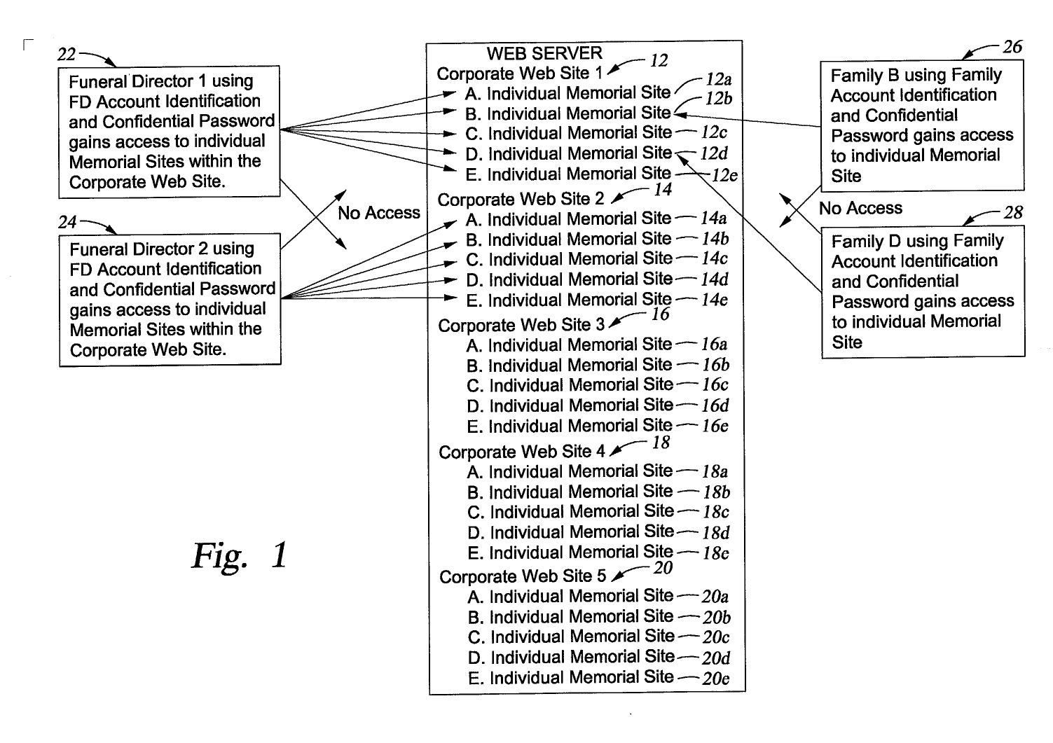

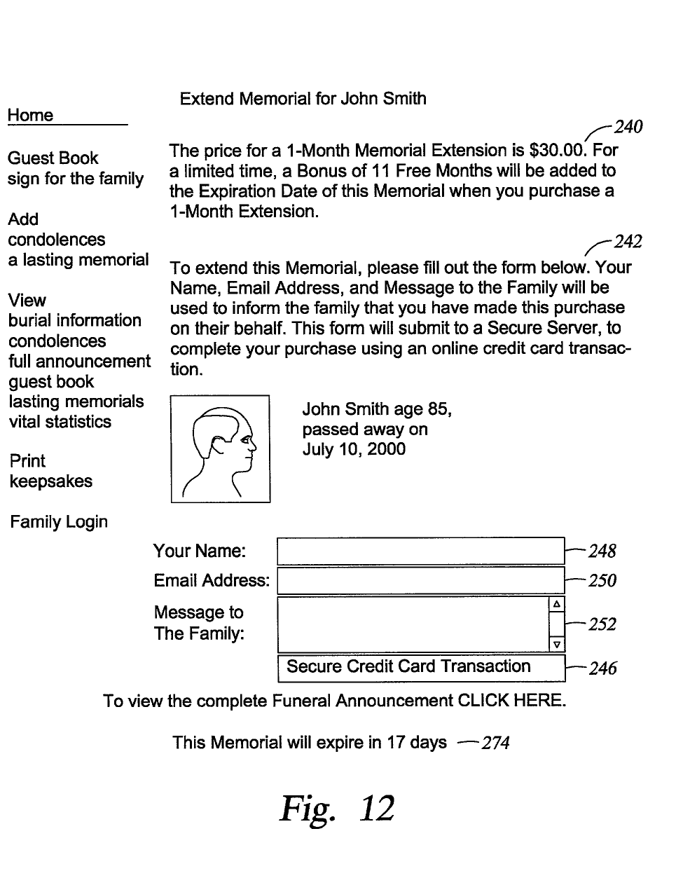

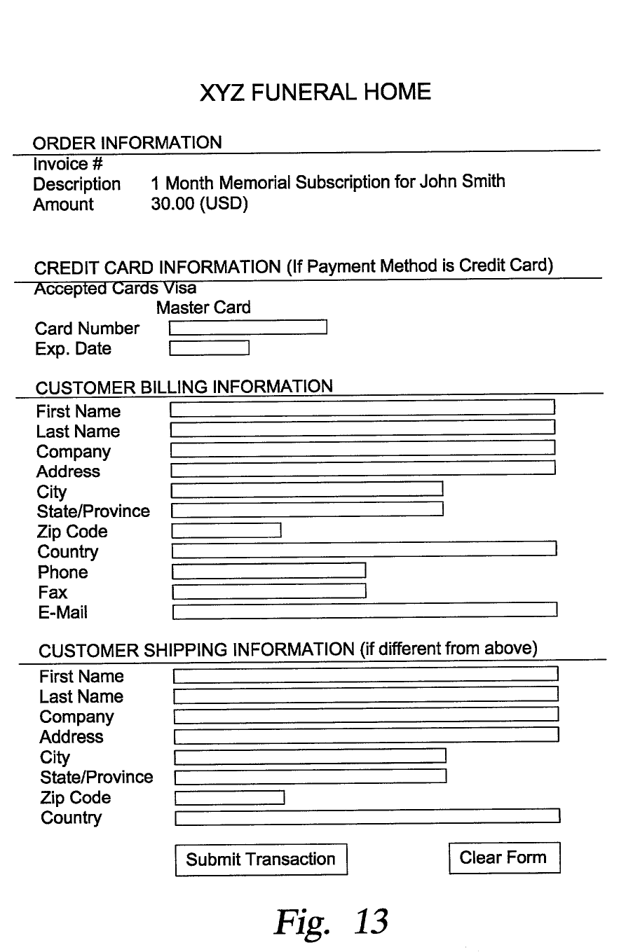

Another example of a memorial page that illustrates certain features of specific embodiments of this invention is shown in FIG. 12. Preferably, the page 238 is located on the memorial site server, e.g., the Web Server in FIG. 1, and can be created using conventional programming language such as ASP. Alternatively, however, a commercially available program such as Storefront can be used to create a similar page. Page 238 includes data symbolic of a request for payment 240, and also the statement 244 that “This Memorial will expire in 17 days,” indicating when the memorial page will be deactivated. The first paragraph 240 of the memorial page explains the procedure for effecting payment, and constitutes a request for payment, since the reader of that paragraph can reasonably conclude that a payment will extend the publication or posting of the memorial page. Note that a variety of sentences and phrases can be used in the place of the sentences and paragraphs in paragraph 240, but communicate that same essential message. The second paragraph 242 describes the procedures for initiating the payment authorization. The fields are filled in by the prospective payor. When the “Secure Credit Card Transaction” button 246 is clicked, the information added to the fields 248, 250, 252 is transmitted directly or indirectly to the Family, and a hyperlink is activated that transfers the user to credit card authorization page found in FIG. 13. Specifically, in the particular embodiment shown in FIG. 12, when button 246 is clicked, the user is routed to Authorize.net's server. In a preferred embodiment, the page that includes a hyperlink 246 to a credit card authorization page is one that, like page 238, also includes a field 248 to place the name of the individual who will by paying for the memorial site, a field 250 for that person's email address and a field 252 for a message to the family. It is contemplated that any friend of the family who wishes to contribute to the family by purchasing an online memorial will also want to send an email message to the family expressing why he is contributing the online memorial.

The information in web page 254 illustrated in FIG. 13 is similar to the information in the bottom portion of FIG. 11. In the specific embodiment shown in FIG. 13, the page is located on Authorize.net's server, which is represented by that company to be a secure environment. When the visitor or other user enters his or her credit card information in the fields, and clicks “Submit Transaction,” the purchase and credit card information that has been entered to the credit card processing service, e.g., Authorize.net for processing. If Authorize.net authorizes the transaction, the visitor is transferred back to the memorial site. While the credit card authorization and processing steps may of course be done by the funeral home or the memorial site operator, it is contemplated that a more efficient procedure is for a separate entity, which specializes in credit card transactions, to handle such procedures, such as Authorize.net.

C. Methods of Creating and Editing Memorial Sites

Generally, certain embodiments of the invention are directed to methods of creating and/or editing memorial sites.

For example, one aspect of this invention is directed to a method of delivering or providing access to an interactive on-line memorial to an Internet user, which includes the steps of (a) providing a website connected to a web server, the website having one or more individual “memorial sites,” the website and memorial sites being accessible on-line via a workstation; (b) providing a password for editing each of the memorial sites, wherein the password is preferably confidential and provides editing access to the one or more memorial sites; (c) accessing the main website and inputting the password to create a first memorial site; and (d) preparing the first memorial site by inputting a first data set to the first memorial site (by transmitting and storing the first data set in server memory, including “preliminary personal information,” including the name of the deceased.

In a specific embodiment, the method described above additionally includes the step of preparing a second memorial site by accessing the website and inputting the same or a different password to gain editing access to and to prepare the second memorial site.

In another specific embodiment, a first workstation has a first level of protected editing access to certain pages of a website by use of a first password; a second workstation has a second level of editing access to a more limited number of pages of the website (preferably the “individual memorial site pages”) by use of a second password; and a third workstation has no editing access to the website, but has viewing access to certain pages of the website.

In still another specific embodiment, the preliminary information of the first data set includes account information, wherein viewing access to the first data set requires use of the first confidential password. In yet another specific embodiment, the first data set comprises a photograph of the deceased. In another aspect of this invention, an on-line funeral home website for creating and editing on-line memorials is provided, having one or more levels of protected (confidential) editing access to different pages of the website. In a specific embodiment, the website includes a first set of pages, which are “multiple memorial site” pages, having at least a first page (e.g., a Director's Page), accessible from a funeral director workstation using a first password (preferably a confidential password). The multiple memorial site pages also include one or more “unassigned” (e.g., blank) templates for inputting information relating to a deceased individual, or the multiple memorial site pages can include a page that provides access to one or more pages that have such one or more templates (e.g., using one or more hyperlinks in the first page). The information that can be inputted into such one or more templates includes account information useful to a funeral director, e.g., billing information; basic personal information relating to the deceased, e.g., name, date of birth and date of death: and memorial information relating to the deceased, e.g., textual information typically found in funeral announcements or obituaries, such as a narrative eulogizing the deceased.

A template (or page containing a template) can be “assigned” to a particular deceased individual by inputting data into one or more of the fields in the template, e.g., by inputting the individual's name or some other identifier (e.g., a number) associated with the individual, resulting in an “assigned memorial site page,” or an “individual memorial site page.” The act of inputting data or information results in an “assigned” or “filled” template which includes “template data” (also referred to as “template information”) which is stored in memory, e.g., on the web server. When the assigned template or filled template is accessed (for viewing or editing) from a workstation, the screen shows a populated template that includes the template along with the stored information.

In another specific embodiment, in addition to the first set of pages described above (the “multiple memorial site pages”), the memorial site further comprises a second set of pages (the “individual memorial site pages”) including at least a second page, wherein the second page includes one or more assigned templates containing information relating to the same deceased individual, or provides access to another page that has such a template (e.g., using a hyperlink in the second page). In that embodiment, the second set of pages is accessible for editing from a family workstation using a second password.

In a specific embodiment, the invention involves a system that is capable of utilizing at least two workstations (funeral workstation and family workstation), with each workstation having on-line viewing access to a website. Different passwords can be used at each workstation to provide different levels of editing access to the “memorial site pages,” which include a “protected first set of pages” (“multiple memorial site pages”) and a “protected second set of pages” (“individual memorial site pages”) both used to edit the personalized memorial site. The first password gives viewing and editing access to the “protected first set of pages” and the second password gives viewing and editing access to the “protected second set of pages.” The “first set of pages” includes at least one blank template (a memorial creation template which is “unassigned”). Preferably, the first set of pages also either includes a protected “Director's Page” or requires going to a publicly viewable “Director's Page” and then inputting the funeral director password before going to the protected first set of pages. Preferably, the first password also provides editing access to the second set of pages. The protected “second set of pages” includes at least one assigned template (the memorial editing template), and requires inputting the family password for access to the second set of pages. The memorial site also includes pages that are “unprotected,” including the displayed memorial, with the announcement (obituary). A third set of pages can also be provided including an account information template and a memorial editing template.

A specific embodiment of this invention involves a funeral home website that includes a memorial site including: (a) a first set of web pages, including at least a first page which includes an unassigned template for inputting information corresponding to a deceased person, the first page being accessible for editing by using a first confidential password; and (b) a second set of web pages, including at least a second page which includes an assigned template for inputting information corresponding to the same deceased person, the second page being accessible for editing by using a second confidential password.

In a specific embodiment, the first set of web pages includes (a) a Director's Page, which can be accessed by clicking a hyperlink on the main website; and (b) one or more pages for creating the memorial site, the one or more pages including one or more blank templates, wherein the one or more pages can be accessed by pressing a hyperlink on the Director's Page, the one or more blank templates including at least a first template having at least one blank field for entering the name of the deceased person.

Also, the one or more templates within the first set of web pages can include a second unassigned template providing at least a second blank field for entering additional information corresponding to the deceased person, the additional information including a narrative describing the deceased person.

In another specific embodiment, the invention relates to a funeral home website stored on a web server, the website including a memorial site having at least two sets of memorial site pages, the first set of memorial site pages including multiple memorial site pages, not being assigned to a specific deceased individual, the second set of memorial site pages including individual memorial site pages, each being assigned to a specific deceased individual, wherein at least some of the multiple memorial site pages can be accessed for editing only by use of a first password and wherein at least some of the individual memorial site pages can be accessed for editing only by use of either the first password or a second password.

Preferably, with that website, the first password is a funeral director password and the second password is a family member password. In that website, the multiple memorial site pages can include a Director's Page.

Also, in the website, the multiple memorial site pages can include at least one unassigned template. Also, the multiple memorial site pages can include a Director's Page, which has a hyperlink to an unassigned page that includes an unfilled template. Further, the individual memorial site pages can include at least one page having a filled or assigned template. Furthermore, the filled or assigned template can include the name of the deceased individual.

Still further, the filled or assigned template can include the date of birth and the date of death of the deceased individual. Moreover, the filled or assigned template can include a funeral announcement, and the funeral announcement can include a narrative relating to the personal history of the deceased individual. Thus, in a specific embodiment, a website can be provided, wherein the multiple memorial site pages include at least one page having an unfilled template and wherein the individual memorial site pages include at least one page having a filled template that is created by inputting information into the unfilled template, the filled template including the name, date of birth, date of death and funeral announcement of the deceased individual that includes a narrative relating to the personal history of the deceased individual.

Another specific embodiment of the invention involves a system for on-line creation and editing of memorials for deceased persons, including a web server associated with a first funeral home website, the web server including one or more memorial sites, each memorial site associated with a deceased person, each memorial site including a first set of memorial site web pages, each first set of memorial site web pages including one or more first level protected web pages requiring a funeral director confidential password associated with the first funeral home website for editing the first level protected web pages.

In yet another specific embodiment, that system can have a memorial site which includes a second set of memorial site web pages, each second set of memorial site web pages including one or more second level protected web pages requiring a family member confidential password assigned to the family of the deceased person.

In still another specific embodiment, the invention involves a system for on-line creation and editing of a memorial for a deceased person, including (a) first confidential access means, including data stored in memory corresponding to a first confidential password to provide access to a first set of web pages corresponding to the deceased person; and (b) second confidential access means, including data stored in memory corresponding to a second confidential password to provide access to a second set of web pages corresponding to the deceased person; wherein © the first and second confidential passwords can be used to create and edit the memorial for the deceased person by inputting information corresponding to the deceased person from different workstations.

In another specific embodiment, the invention includes a system for on-line creation and editing of a personalized memorial for a deceased person, including a funeral workstation located in a funeral home and at least one family workstation not located in the funeral home, each workstation having on-line viewing access to a web site associated with the funeral home, the web site including or being linked to a memorial site which includes one or more memorial site pages associated with the deceased person, wherein different passwords provide different levels of editing access to the memorial site pages, including a first password providing a first level of protected editing access to a first set of web pages forming part or all of the memorial site pages and a second password providing a second level of protected editing access to a second set of web pages forming a subset of the memorial site pages, wherein the protected access provides the user with the ability to create or edit the personalized memorial.

With that system, the first set of web pages can include a first template for entering basic personal information relating to the deceased person, including the name of the deceased. With that system, the memorial site pages can include unprotected web pages, including a displayed memorial page, which contains the announcement or obituary of the deceased person and a photograph of the deceased person.

Another specific embodiment of this invention involves a system for providing on-line access to a funeral home website, which includes a personalized memorial site for a deceased individual, the system including: a web server having web pages stored in memory; the web pages including a first set of pages, the first set of pages being accessible by use of a funeral director password, wherein the funeral director password can be transmitted to the web server from a first workstation connected on-line to the web server; and the web pages further including a second set of pages, the second set of pages being accessible by use of either the funeral director password or a family member password, wherein the family member password can be transmitted to the web server from either the first workstation or a second workstation connected on-line to the web server; wherein the web pages include at least one page having an unassigned template for creating a personalized memorial site for a deceased individual; wherein an assigned template containing the personalized memorial can be created by inputting personal information into the unassigned template from the first workstation using the funeral director password; and wherein the assigned template forms part of the second set of pages and can be edited from either the first workstation using the funeral director password or the second workstation using the family member password.

Preferably, in that system, the first set of web pages further includes a second template for inputting a funeral announcement relating to the deceased person, including a personal history of the deceased person. Preferably also, in that system, the second set of web pages includes a third template that includes the personal history of the deceased person from the second template.

In another broad aspect, the invention relates to one or more methods. In a specific aspect, the invention includes a method of providing an interactive on-line memorial for funeral homes, including the steps of: (a) providing one or more memorial sites associated with a funeral home website, the funeral home main website and the one or more memorial sites being accessible on-line via a funeral home workstation; and (b) providing a funeral home password for editing the one or more memorial sites from the funeral home workstation, the funeral home password providing editing access to the one or more memorial sites; wherein (c) a first memorial site can be prepared for a first deceased person by a funeral director associated with the funeral home by accessing the funeral home main website and inputting the funeral home password to gain editing access to the first memorial site and then inputting a first data set to the first memorial site, the first data set including preliminary information, including the name of the first deceased person.

Another specific embodiment of the invention includes a method of providing an interactive on-line memorial, including the steps of: (a) providing a website connected to a web server, the website having one or more memorial sites, the website and the memorial sites being accessible online via a workstation; (b) providing a password for editing the one or more memorial sites from a central workstation, wherein the password provides editing access to the one or more memorial sites; (c) accessing the website and inputting the password to gain editing access to the first memorial site; and (d) preparing the first memorial site for a first deceased person by inputting a first data set to the first memorial site, the first data set including preliminary information, including the name of the first deceased person.

This method preferably additionally includes the step of preparing a second memorial site for a second deceased person, by: (a) accessing the main website; (b) inputting the password to gain editing access to the second memorial site; (c) creating the second memorial site; and (d) inputting a second data set to the second memorial site, the second data set including preliminary information, including the name of the second deceased person.

This method also preferably involves a first workstation having a first level of editing access to the memorial site by use of a first confidential password; a second workstation having a second level of editing access to the memorial site by use of a second confidential password; and a third workstation with no editing access to the memorial site, but having viewing access to the memorial site. With this method, the preliminary information preferably includes account information, and viewing access to the first data set preferably requires use of a first confidential password.

Another specific embodiment of the method of this invention involves a method for creating a personalized on-line memorial site for a deceased individual, the memorial site being part of a funeral home website stored on a web server, the method including the steps of: logging onto the website from a workstation; inputting a password from the workstation to gain editing access to a first set of pages, the first set of pages being protected from access by users who do not input the password, wherein the first set of pages includes a page having a first template having fields for inputting the deceased individual's name, date of birth, date of death and personal history; and filling the fields in the first template by inputting personal information in the fields, the personal information including the deceased individual's name, to provide a second template assigned to the deceased individual, the second template including at least some of the fields of the first template along with the inputted personal information, such information being stored in memory on the web server, the second template being accessible for on-line editing from the funeral home workstation, wherein a memorial display page is provided, the memorial display page being stored on the web server, the memorial display page including the personal information inputted into the first template, the memorial display page being accessible on-line to users without a password.

Preferably, with this method, the personal information additionally includes the date of birth, date of death and personal history. Also, the workstation is preferably a funeral director workstation, located in a funeral home. Preferably, the second template forms part of a second set of pages, the second template being accessible for editing by use of a family password. Also, the password is preferably a funeral director password. In a preferred embodiment, the second template forms part of a second set of pages, the second template being accessible for editing by use of a family member password, wherein the method additionally includes the step of editing the second template using either the funeral director password or the family member password to provide an altered second template stored in the web server, and to provide an altered display page stored in the web server, the altered memorial display page being accessible on-line to users without use of either the funeral director password or the family member password.

D. Creation of Memorial Sites Using Confidential Passwords

A specific embodiment of this invention relates to a method of creating an Internet-accessible memorial website that includes the step of inputting one or more passwords for the purpose of creating and editing a memorial site, to provide a displayed memorial. A password (preferably confidential) provides protected editing access to any “protected area” on the web site, i.e., “protected pages.” Preferably, where a confidential password is used, a user identifier is also inputted along with the confidential password, as well as any other “access rights” text. Preferably, the confidential password is not displayed on the screen but rather appears as a series of asterisks (˜*******˜˜) so that onlookers cannot easily learn the confidential password. In a specific embodiment, the confidential passwords are typed in along with an account identifier or identification number. In a specific embodiment, a single private confidential password is used for a particular corporate web site, preferably by a funeral director. The confidential password can be used to access different individual memorial sites and preferably corresponds to an individual funeral director (FD), in which case it may be referred to herein as a funeral director password (FDP). Alternatively, the single password can also correspond to a single funeral home, with multiple funeral directors sharing the same password. In either case, the password is preferably associated with a single funeral home, allowing a funeral director at the funeral home to create a plurality (multitude) of individual memorial sites on a single main website. This password is thus distinguished from any password that might be used by the ISP or other entity controlling the server, as well as a password that a remote user (e.g., a guest) might use to gain on-line access, e.g., an AOL password. Thus, in a specific embodiment, a single server (e.g., the web server) will preferably have more than one confidential passwords that can be used, each one associated with a single funeral home or funeral director, each funeral director or funeral home preferably having a main or corporate website. Similarly, in a specific embodiment, each main website will have a plurality (more than one) memorial sites, each memorial site having a corresponding confidential password for the family members to have access to the memorial site (e.g., a family member password).

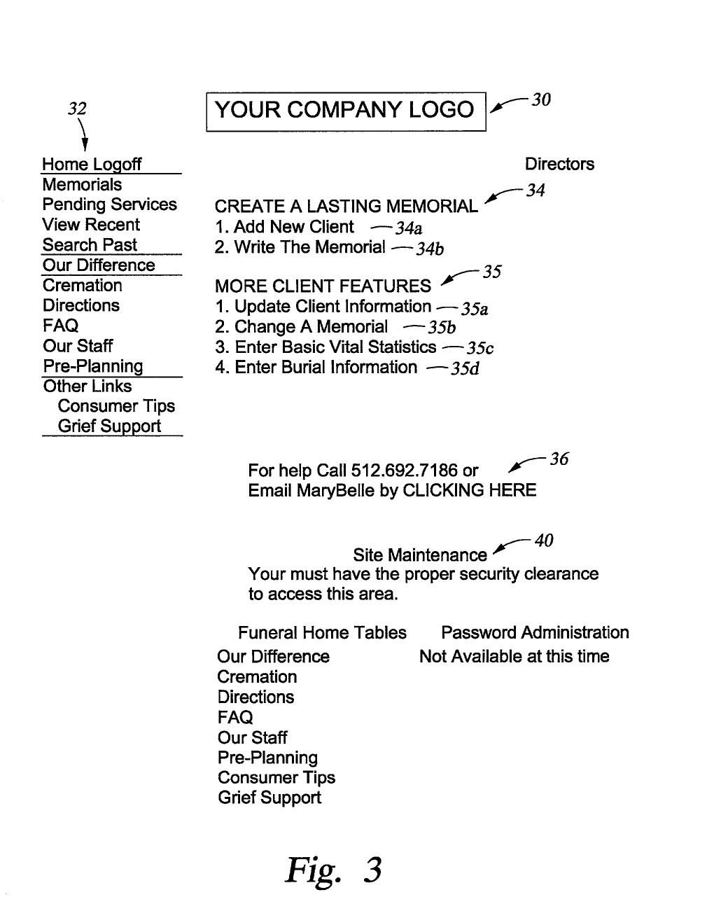

In a specific embodiment of the invention, which will now be described, a main website corresponds to a single funeral home, the main website having a plurality of memorial sites. The funeral director (FD) preferably views the main website, e.g., by typing in the publicly accessible domain name of the website (not the confidential password). (For example, a hypothetical domain name might be “www.acmefuneralhome.com.”) By viewing the main website, the funeral director is able to browse the web site, which contains the memorial sites. Having viewed the main website, the funeral director can then move to a discrete “editing page,” which provides access to pages that can be edited. Preferably, this page is one that is a “multiple memorial site page,” meaning that it is not restricted to a particular individual memorial site, but functions as a “gateway” to the individual memorial sites. In a specific embodiment, a private “Director's Page” is provided, which functions as such a “gateway.” The funeral director gains access to the Director's Page using the confidential password (e.g., the FDP). An example of a Director's Page from a hypothetical main website is reproduced in FIG.3 Having accessed the Director's Page using the FDP, the funeral director is then able to transmit data and execute instructions to the web server and thus create and/or edit any one of the individual memorial sites, ideally giving the funeral director exclusive or protected control over the contents of the individual memorial sites. The term “exclusive” in this context refers to an ideal situation, leaving open the possibility of a “hacker” being able to somehow access the Director's Page, and also leaving open the possibility that an unauthorized person will somehow obtain the confidential FDP.

It is understood that many of the website pages are preferably accessible to any member of the public for viewing purposes, but not for editing purposes, such as the funeral home “home page” and the memorial “display” page. These pages should be capable of being accessed for on-line viewing by any member of the public, by that person simply browsing the main website and typing in a word, e.g., the name of the deceased individual, or viewing and then “clicking” onto a list of pending or past funerals. As indicated above, a single funeral home may typically have a plurality of individual memorial sites, each one preferably corresponding to a deceased individual. To the extent the FDP is confidential, the funeral director can then use the Internet to create and edit this individual memorial site, while others are prevented or at least hindered from modifying the content of the individual memorial site, except in another specific embodiment as discussed below, where one or more additional passwords (a “second password”) is provided to selected individuals for a individual given memorial site.

Preferably, after entering the editing mode by accessing the Director's Page using the FDP, the funeral director begins to create the personalized memorial site. He typically begins by configuring (setting up) an account for the deceased, preferably using one or more blank “templates” (forms) that are preferably already part of the memorial site. These templates are discussed in greater detail below. Any of the templates may include one or more blank fields which can be completed (partially or completely filled), preferably, by “pointing and clicking,” using a mouse to move to a particular field within the template, and by typing in alphanumeric data within that field. Alternatively, it is contemplated that conventional voice recognition software can be used to input the information into the template. After setting up the account, using the appropriate procedure, the funeral director can then enter basic personal information. This basic personal information will typically include the name of the deceased and information concerning the funeral services (time, place and possibly a map showing the location of the funeral services), all of which can usually be accomplished without involvement of the family members. The funeral director may also begin to write an obituary for the deceased. As discussed above, by using his editing password, the funeral director can write the obituary- either at the time he is initially setting up the account and entering the basic personal information, or later, after getting input and feedback from the family members. Also, the funeral director can scan in a photograph of the deceased, which then becomes part of the memorial site. Based on this invention and the disclosure in this patent, a person skilled in the art of developing funeral home websites will recognize a variety of other textual and visual information that can be entered into the memorial site, by either typing or “speaking” in the information (using voice recognition software). The above discussion is thus by way of example only, and the present invention is neither limited by the procedure described above, nor by the types of information described above.

A contemplated benefit of the FDP is the flexibility and time allocation capabilities it provides the funeral director. Once the individual memorial site is initially created and stored in the web server, it can be retrieved at any time for editing, using the FDP. Thus, the displayed memorial page is not “static.” Using the FDP, the funeral director can “log on” at any time to access the individual memorial site for editing. “log off” after inputting or editing information, then “log on” again later at the funeral director's convenience. Such flexibility should offer a tremendous benefit to funeral directors, so that their time spent “on-line” can be allocated at their convenience. Another benefit of this flexibility is that the content of the individual memorial site can be edited, corrected or modified at any time, either before or after publication of the individual memorial site on the website (e.g., the displayed memorial page).

E. Use of Dual Editing Passwords

A preferred embodiment of this invention relates to a method of creating an Internet-accessible memorial website that includes the step of inputting at least two private confidential passwords for a given memorial site, each confidential password having different levels of “protection,” i.e., confidential editing access. As discussed above, each of these confidential passwords can be either an alphabetical word or a numeric code or some alphanumeric combination, and can also include or be associated with a user name and an account identifier, e.g., an account identification number). Thus, as discussed above, the confidential password can be (or have associated therewith) a user identification code, or an account validation or personal verification code, or any other item of data that can be inputted and that gives the user editing access to the memorial site. With this dual-password version of the invention, the first password is preferably the password such as the one described above, which preferably is a funeral director confidential password, which corresponds to a single main website and can be used to gain editing access to a plurality of memorial sites on that main website.

In contrast to the first password, the second password is more limited in terms of the access it provides, and can be used to gain editing access to a limited number of individual memorial sites, preferably a single individual memorial site, and can also be limited as to how many pages within that individual memorial site can be accessed for editing purposes. The second password is preferably used only by family members of the deceased or others having a close relationship to the deceased. That is, the second password is not typically made available or known to the general public or others that have not been given the second password (unless provided by the family members, e.g., in a funeral announcement). In a specific embodiment, the second password may be referred to herein as a family member password (FMP) or family member confidential password.

In the dual-password embodiment of the invention, after meeting with the family members (e.g., personally or over the telephone), the funeral director preferably assigns them one or more FMPs, which gives the family members limited editing access to certain memorial site pages, which the funeral director will typically have already set up as discussed above. Using the FMP, the family members can edit or change certain memorial information (e.g., obituary information) on the individual memorial site. In a specific embodiment, the family members begin by logging on their computer and using their on-line service provider password (e.g., an AOL password) to get on the Internet. They may then access the funeral director's main website, e.g., by entering the domain name of the funeral director or funeral home (hypothetically, “www.acmefuneral-home.com”) or by linking from another funeral home website. That is, in certain cases, the funeral home will have another website in addition to the main website, e.g., a pre-existing website located on a different web server. In those cases, the pre-existing website can be linked (e.g., by hyperlink) to the main website, which includes the memorial site pages. At the appropriate web page on the main website, they would then enter the FMP, providing them with limited editing access to their particular individual memorial site. The family members will then preferably use one or more templates (discussed below) to input family information into the individual memorial site that has not already been or will not be inputted by the funeral director. It is contemplated that this “family information” will include information typically found in obituaries, e.g., a narrative that pays tribute to the deceased. The family information may also include photographs. The family members can also correct or edit information already inputted (entered) by the funeral director, e.g., correction of the spelling of names.

F. Templates

One of the features of this invention is the use of one or more “templates” (forms) which include one or more blank fields for inputting information. In a specific embodiment of the invention, the main website has a single unfilled template, which has different fields for entering or inputting information. In another specific embodiment, the website has multiple templates, each having its own set of specific customized fields. It is contemplated that multiple templates can provide added flexibility, supplying the ability to tailor each template to an individual funeral home, and also the ability to customize individual templates without disturbing the other templates.

It is understood that each of the templates described below (first, second, third, etc.) is deemed to include an initial template (referred to herein as a “blank” or “unfilled” template), which is stored on a server, and is not assigned to any individual memorial site, but rather is a “multiple memorial site” template. After data is inputted, into one or more fields of the template, a “filled” or “assigned” template is generated by the forms software (e.g., in the web server or in an application server connected to the web server). The filled or assigned template includes both the initial blank template and the inputted data that is stored in a database, e.g., in the web server. The screen shows these two in combined form as a template filled with the data. As used herein, an “assigned” or “filled” template is deemed to be part of the individual memorial site.

In a preferred embodiment, the memorial site has at least one page with a first blank or unfilled template (e.g., an “administrative form”) for inputting account information corresponding to the deceased or the family of the deceased. Once partially or completely filled (e.g., “assigned”) a filled template is generated, with the account information being stored in memory, e.g., in a database on the web server. Preferably, in this embodiment, the assigned template is not accessible using the family member password. Preferably, this filled template is accessible for viewing and editing only by the funeral director, and not members of the public or the family members, even with the FMP. The first filled template has details about the deceased and the family that is intended for the funeral director only, e.g., the type of casket, flowers, place and time of the funeral and the like. (It is noted that some of these details may also be found in the other templates.) The first filled template may also include cost and billing information, and may be combined with billing software to include the ability to automatically print out or otherwise transmit invoices, i.e., automated invoice generation.

A page with a second blank template (e.g., a “memorial form”) may also be provided. When data corresponding to the blank fields are inputted and transmitted to the web server, the result is a filled second template stored on the web server. As discussed above, the template itself and the template data are typically stored in separate locations on the server. This second filled template is accessible for viewing by both the funeral director (using the funeral director password) and the family members (using the family password), but can be made accessible for editing only by the funeral director using the funeral director's password. Using this second filled template, the funeral director can allow the family members to view information that is relevant to the funeral (e.g., type of casket, flowers, place and time of funeral), but that the family members are not able to modify (edit). This non-editing access feature enables the funeral director to maintain appropriate control over the funeral services, for which the funeral director is responsible, and protects against unwanted editing.

A page with a third template may also be provided. Again, when the fields are filled, so that data is transmitted to the web server and stored in memory, a filled third template is provided, which is accessible for both viewing and editing by both the funeral director (using the funeral director password) and the family members (using the family password). The third filled template includes fields for adding more personal details about the deceased that the funeral director may not have access to or time to determine, including significant dates such as dates of birth and death. Preferably, the third template also includes one or more fields for writing an obituary, including a field for writing a narrative regarding the life of the deceased. Separate fields may also be provided for specific data such as high school and college attended, dates of graduation, names of surviving relatives and the like.

A page with a fourth template may be provided for scanning in film-based photographs or for transferring digitized photographic images, using conventional imaging technology, to provide a fourth filled template.

A page having a fifth template may be provided as well. Again, by transmitting the information to the server, the forms software generates a fifth filled template, with additional fields that do not require passwords for editing access, so that members of the public and friends of the deceased can add comments or photographs regarding the deceased from remote locations, e.g., from their home computers and/or using their own scanners or imaging technology.

In another specific embodiment of this invention, not having all five templates described above, a page with a template is provided that includes the information described above in connection with the third template, i.e., the ability to write and edit the obituary from home. That aspect of the invention is particularly advantageous to both the family members and the funeral director. On the one hand, it gives the family members total control (and responsibility) over the actual content of the obituary narrative, which is one of the shortcomings of previous memorials. Because it can be accessed from the family's own home, the writing and editing process can be done in a more conducive atmosphere. On the other hand, the remote editing access feature is also a benefit to the funeral director, who with this feature of the invention does not bear the entire responsibility for the content of the obituary. This interactive aspect also makes it easier for the funeral director to manage communications with the family members and makes his efforts more effective and efficient. It will be recognized, of course, that the invention is not limited to the above-described templates, and that a variety of template combinations can be provided, each having different fields, depending on the needs and/or desires of the individual or entity administering the memorial site, e.g., the funeral home. Commercially available software for developing such templates is described elsewhere in this patent.

G. Living Memorials

As used herein, the “subject name” refers to the person who is the subject of the memorial. When a “lasting memorial” is being created, the subject name is the name of the deceased individual. In an alternative embodiment of the invention, when a “living memorial” is being created, the subject name refers to a living individual, who can participate in the writing of portions of his memorial in advance of his death. With this embodiment, the methods described above in connection with a deceased individual can be used in connection with a living individual. In that case, rather than writing an obituary, the family members participate in writing a tribute; the first password being provided to the person or entity administering the “living” memorial site, and the second password being provided to the family members (including the subject of the tribute) who are involved with the writing of the memorial or tribute. Also, in this embodiment, it is a living individual rather than deceased individual who is the subject of the individual memorial site.

H. Specific Embodiments of Invention

Several specific embodiments of the invention will now be described, incorporating various aspects of the invention discussed above. These embodiments do not limit the scope of the invention, which is defined by reference to the claims below, including the substantial equivalents of the various elements and limitations, but it will be useful in understanding the invention. Thus, as used below, the term “invention” is not used in a limiting sense.

FIG. 1 is schematic chart that reflects the relationship between the various parts of that invention. The web server 10 has multiple corporate web sites Nos. 1-5 (12, 14, 16, 18, 20), which are preferably web sites corresponding to individual funeral homes. The corporate web site is a specific type of “main web site.” Each corporate web site includes multiple individual memorial sites. Various procedures for creating the memorial sites are described below and elsewhere herein. As indicated by box 22, Funeral Director 1 uses a confidential password, along with a funeral director user or account identification number, to gain access to individual memorial sites within the corporate web site. Meanwhile, as shown schematically by box 24, funeral director 2 uses a different funeral director confidential password, along with a different user or account identification number, to gain access to individual memorial sites within his particular corporate web site. Note that one funeral director, from his own corporate web site, preferably cannot gain access (i.e., access for editing purposes) to the other funeral director's memorial sites, from his corporate web site. By inputting his respective funeral director confidential password, each funeral director can be directed to a page (e.g., the “Director's Page”) on his corporate web site, which will enable him to begin creating an individual memorial site. After the individual memorial site is created, each family member can then also gain access to certain pages or portions of the memorial site. The family members can also view (but not edit) certain pages of the individual memorial site, e.g., those that do not require the funeral director confidential password for access. The family members can gain access to selected pages (i.e., for editing purposes) using the family member password. Thus, referring to box 26 of FIG. 1, while family B can use its family member password for accessing its corresponding individual memorial site, it cannot use its family member password for accessing any other individual memorial site on the same corporate web site, e.g., individual memorial sites 12a, 12c, 12d, or 12e. Likewise, referring to box 28, family member D can access individual memorial site 12d only.

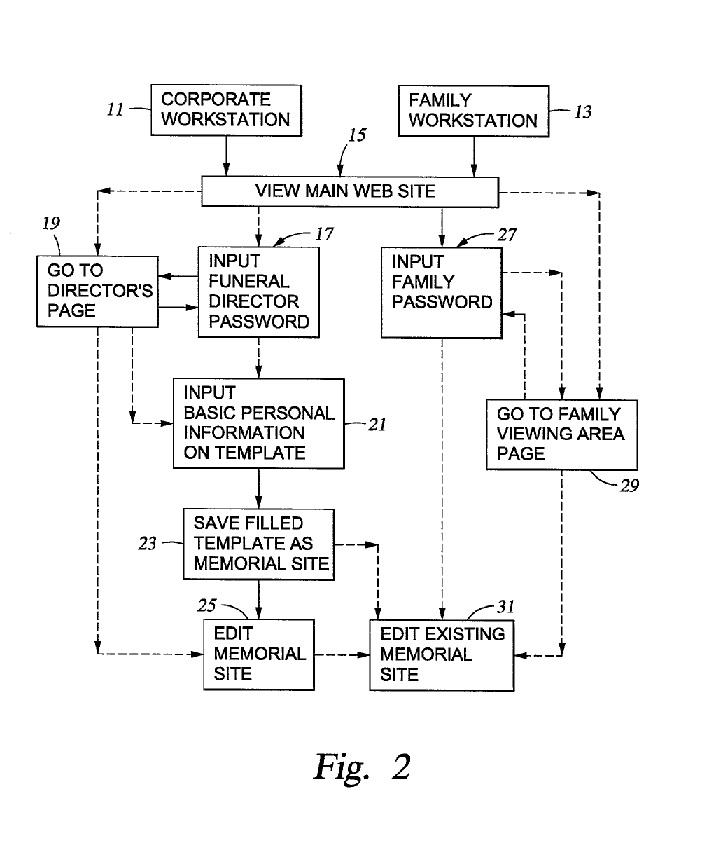

FIG. 2 is a flow chart showing the steps that are followed to create an interactive memorial for a specific embodiment of the invention. A funeral director can use his corporate workstation 11 to view the main website (e.g., the funeral home web site) by typing in the funeral home's domain name (e.g., “www.acmefuneralhome.com”). A family member can use his family workstation 13 to view the same main website by typing in the same domain name. In one embodiment, the funeral director inputs the funeral director's confidential password 17, providing him with editing access for creating a individual memorial site, by directing him to the protected Director's Page 19. In an alternative embodiment, the funeral director can access the Director's Page 19 from the main web site without the need for a funeral director's confidential password, but needs to input the funeral director password for editing access to the individual memorial site. In either case, as shown in FIG. 2, basic personal information is inputted on a protected blank template 21, accessible either from the Director's Page 19 (provided the funeral director's password has been used to enter the Director's Page 19) or from the main website 15 (provided the funeral director password has been first entered). Other intermediate pages (not shown) can of course be used, such as pages that ask for inputting of 10 the funeral director password. After the basic personal information is inputted on the blank template, e.g., the name of the deceased, template software generates a filled template which is stored on the web server, thus creating the individual memorial site. This individual memorial site can then be edited 25 at any time. For example, a funeral director can log onto his workstation 11, view the main web site 15, input the funeral director's password 17, go to the Director's Page 19 and edit the saved individual memorial site 25.

FIG. 2 also illustrates how a family member can edit the same individual memorial site from a family workstation. In one embodiment, the family member views the main web site, inputs the family password 27, and goes to the family viewing area page 29, which includes a hyperlink that provides access to a page wherein he can edit the existing individual memorial site 31. In another embodiment, the family member views the main web site, goes to the family viewing area, and inputs the family password, providing editing access to a filled template where the existing individual memorial site can be edited 31. Note that the family password does not provide editing access to the blank template that is filled in by the funeral director 21, while the family password does provide editing access to another template that includes the filled (including partially filled) memorial site. Numerous other pages (not shown) can be added to the basic configuration of pages and commands shown in FIG. 2. For example, as described elsewhere herein, the family members 5 can fill in other templates (and create corresponding filled templates) that contain fields similar to the basic personal information template 21 (e.g., a vital statistics template). Similarly, a variety of combinations and pathways to different pages can be associated with a single memorial site, all preferably being interconnected by hyperlinks. Nevertheless, a critical feature of the specific embodiment shown in FIG. 2 is the requirement of (1) a funeral director password for protected editing access to a first set of pages, including at least one page with a first template that is not accessible to the family members (e.g., for basic personal and/or account information) and at least one page with a second template for creating the narrative corresponding to the memorial (e.g., the announcement or obituary); and (2) a family password for protected editing access to a second set of pages, the second set of pages being a subset of the first set of pages, the second set of pages including at least one page with a third template for editing the narrative corresponding to the memorial, the third template preferably containing the saved contents of the second template that is filled in by the funeral director.

FIG. 3 shows an example of a web page in which the funeral director can begin to create an individual memorial site. This page may be referred to as the “Director's Page.” The “Company Logo” 30 preferably includes the name of the funeral home, including any desired design features, and may also correspond to the logo used in any other funeral home website. Preferably, the Directors Page cannot be viewed by anyone other than the funeral director, i.e., it cannot be viewed by the family members or members of the public. In this way, the funeral director can be assured that his procedures for creating the individual memorial site are private, confidential and protected. Preferably, the Director's Page is the “starting point” for the funeral director to create the individual memorial site. It can also be a place where the funeral director holds some or all of the relevant account information, including costs and billing information. The content of the Director's Page can be controlled by the funeral home, or by the entity that maintains and controls the web server and web site, typically either a web hosting service or an administrator authorized by that web hosting service, who is capable of periodically providing updated information specific to the funeral business.

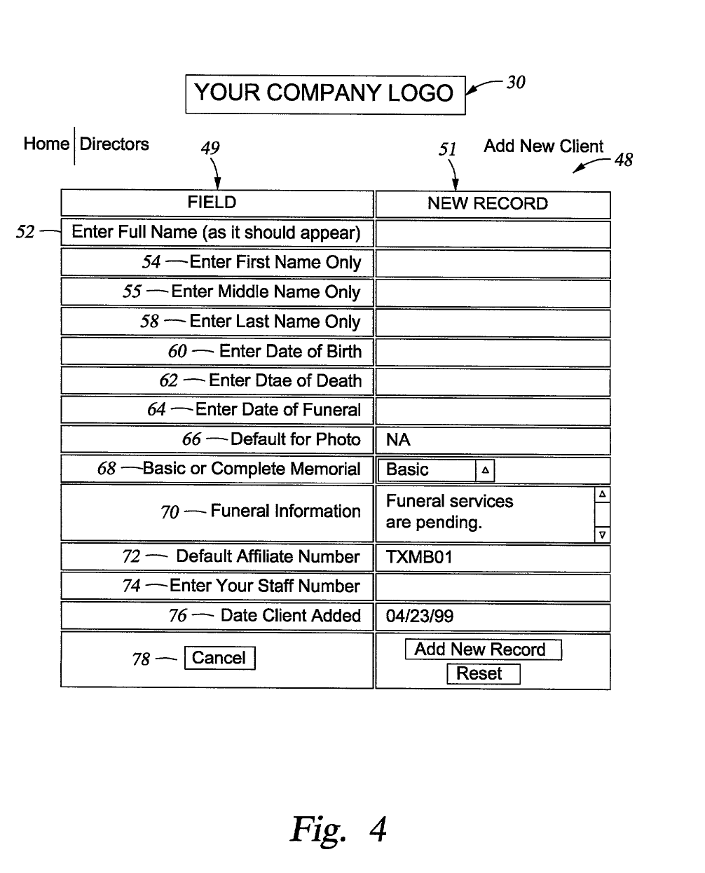

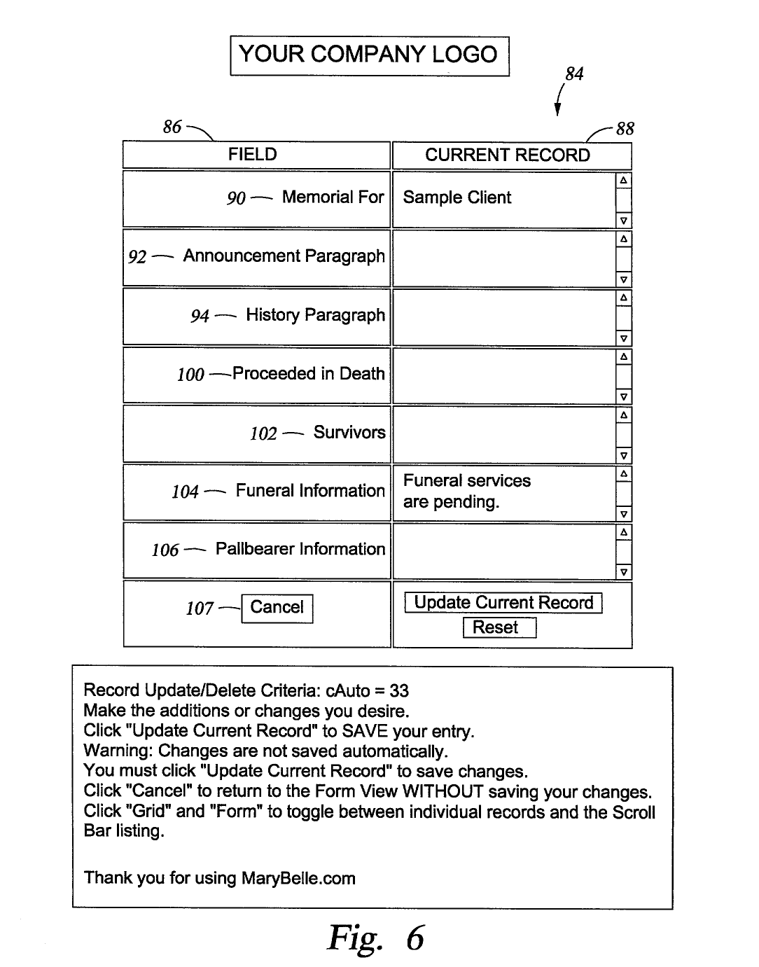

Referring now to FIG. 3, the Director's Page preferably includes hyperlinks that enable a user (e.g., a funeral director) to view (and in some cases, access) other web pages, by pointing and clicking (or by typing in manually or speaking with voice recognition software). The Director's Page includes various descriptive text and hyperlinks described below. The side menu 32 contains various headings and hyperlinks, which are preferably also shown 15 on the funeral home's “home page.” That is, the same side menu 32 headings and hyperlinks are also viewable by the family members and/or any member of the public who is browsing the web site from a different page. The side menu 32 includes a “Home” hyperlink, which allows the user to view the web sites' home page, and “Logoff,” which enables the user to log off the web site. Side menu hyperlinks listed under the heading “memorials” include “Pending Services” listing all the pending (future) funeral services, “View Recent,” which lists selected recent (past) funeral services, and “Search Past” which contains a listing of all past funeral services. Side menu hyperlinks listed under the heading “Our Difference” include “Cremation,” which describes cremation options, e.g., pricing and procedures, “Directions,” which describes directions for using the funeral home services, “FAQ,” which provides answers to “frequently asked questions,” “Our Staff,” which describes the funeral home staff, and “Pre-Planning,” which describes planning options for a funeral in advance, such as burial sites, caskets, etc. Other hyperlinks appear under the hearing “Other Links,” such as “Consumer Tips,” which describe to potential customers, e.g., family members, how to best utilize funeral services in terms of timing, casket purchasing, pre-planning, etc. The “Grief Support” hyperlink describes ways in which the funeral home can assist the family members during their period of grieving for the deceased. The main web site will typically include many other pages that are not described herein, including pages that may be part of the general side menu. The body of the Director's Page includes descriptive text, in outline format, and also includes primary hyperlinks 34, 35, which are hyperlinks that provide access to the pages corresponding to the hyperlinks only from the Director's Page. The Director's Page is preferably both accessible and viewable only by the use of the funeral director's confidential password, and is not accessible or viewable by the public or even the family members with a family password. Thus, the primary hyperlinks can only be accessed by the use of the funeral director password. The “Create A Lasting Memorial” heading 34 refers to multiple hyperlinks including the “Add New Client” hyperlink 34a (providing access to a page described below with reference to FIG. 4) and “Write The Memorial” hyperlink 34b (providing access to a page described below with reference to FIG. 6). The purpose of the “Create A Lasting Memorial” hyperlinks is to allow the funeral director to begin creating the memorial site for a particular deceased individual in a protected environment.

Other primary hyperlinks can be provided, including the More Client Features hyperlinks 35. Preferably, the pages identified by “More Client Features” hyperlinks 35 are only accessible to the funeral director using the FD Password. e.g., for the Director's Page. The “Update Client Information” hyperlink 35a, “Change A Memorial” hyperlink 35b, “Enter Basic Vital Statistics” hyperlink 35c and “Enter Burial Information” 35d provide access to various other pages within the memorial site. Other hyperlinks include a “Help” hyperlink 36 that allows the funeral director to contact the web host (or memorial site administrator) by telephone or interactive E-mail communication. Various “Print Options” hyperlinks (not shown) can also be provided for printing the contents of particular pages, e.g., the memorial site, in newspaper format (e.g., for obituaries).

Other hyperlinks, listed under “Site Maintenance” 40 are also provided. These require the 10 use of a confidential password (“the proper security clearance”) for access to the corresponding page. Typically, the confidential password will be the funeral director's password, and, because the Director's Page is only accessible using the funeral director's password, the pages corresponding to the Site Maintenance hyperlinks are accessible only from the Director's Page. Thus, using the Site Maintenance hyperlinks, information in the pages that correspond to the side menu 32 hyperlinks 15 can be edited. Thus, for example, the funeral director can click on the “Our Difference” hyperlink under Site Maintenance 40 to edit the page that describes the particular funeral home, which can be viewed (but not edited) by clicking the “Our Difference” hyperlink on the Side Menu 32.

FIG. 4 shows the screen (page) that is accessed by clicking the “Add New Client” hyperlink 34b from the Director's Page (FIG. 3). The page includes a blank template (form) 48 which the funeral director uses to open an account corresponding to a new memorial site. Once data is added to the fields, e.g., the name of the deceased is typed in and save, so that the name is transmitted to and stored on the web server, the template then becomes an “assigned” (partially filled) template, which becomes an individual memorial site page,” which can be edited later by entering the funeral director or family member. But as discussed below, the template 48 is “blank” since no data has been inputted. In this specific embodiment, this template 48 is accessible by hyperlink from the Director's Page, and is thus protected. However, in an alternative version of this invention, this template can be accessed (preferably by hyperlink) directly from the main web site, although both viewing of and access (for editing) to the filled counterpart of this template preferably requires inputting of a confidential password (e.g., the funeral director's password), so that the Add New Client template 48 is protected from unwanted editing access. While in the alternative version, such viewing ability and editing access will preferably require some intermediate page that asks for this confidential password, it is contemplated that the website can alternatively be configured so that mere inputting of the confidential password (or selected text that includes the confidential password) will also provide direct access to the filled counterpart of this “Add New Client” page. For example, the web site could be configured so that (if the confidential password is “hokey”), the inputting of “hokey-addnewclient” would send the user (funeral director) directly to this page, without having to go through the intermediate step of going to the Director's Page. Similarly, a web site can be configured so that any of the other pages that require a confidential password for viewing or editing access can be accessed directly without going to the intermediate Director's Page. Nevertheless, in a preferred embodiment, the blank “Add New Client” template 48 can be accessed only from the Director's Page, at the point where the individual memorial site is initially created. Template 48 and its filled counterpart (not shown) includes certain basic information that is intended for viewing and editing access by the funeral director only, and not by either the family members or members of the public. Preferably, the template 48 includes a “Field” identification column 49, which identifies the various fields, is permanent and is not subject to editing; and a “New Record” column 51, which contains blank spaces designed for inputting information. In the specific embodiment shown, the basic personal information includes name information of the deceased individual, i.e., his full name 52; first name 54; middle name 56; and last name 58. The personal information also includes fields for significant dates, i.e., the Date of Birth field 60; Date of Death field 62; and Date of Funeral field 64.

Template 48 can also include other fields. Although these other fields are shown as viewable in FIG. 4, they can also be hidden from the funeral director, viewable and accessible to only the web hosting service or memorial site administrator who preferably has the ability to edit all the pages on the main web site. Those other fields include a field 66 for a photograph, in which the default provision (when the field is empty or improperly filled) is “photo not available.” Also included is “Basic or Complete Memorial” 68; and “Funeral Information” 70 (e.g., “Funeral services are pending.”) The “Default Affiliate Number” 72 is preferably included automatically, and can be some text string identifier assigned to the particular “affiliate” or funeral home that owns (or leases) the particular corporate web site. The “Enter Your Staff Number” field 74 preferably refers to the funeral director's confidential password or some other identifier corresponding to an individual employee of the funeral home, so that the identity of the person inputting the information into the template can later be identified. The “Date Client Added” field 76 refers to the date information in template 48 was first added, and this date can be provided automatically by a conventional date stamp within the software used to create the filled template, e.g., ASP-db Enterprise by Major Micro Systems.

Finally, an “action” field 78 is provided, which, by clicking on “Cancel,” returns the user to another screen (and a different template) without saving (e.g., without storing in the server) any of the data inputted into the template. By clicking on “Reset,” the typed in information appearing on the screen in Template 48 can be erased and the same blank template can be reused. But clicking the “Add New Record” button, the data inputted on the template gets saved and stored on the web server. A new blank screen with the same blank “Add New Client” template 48 then appears.

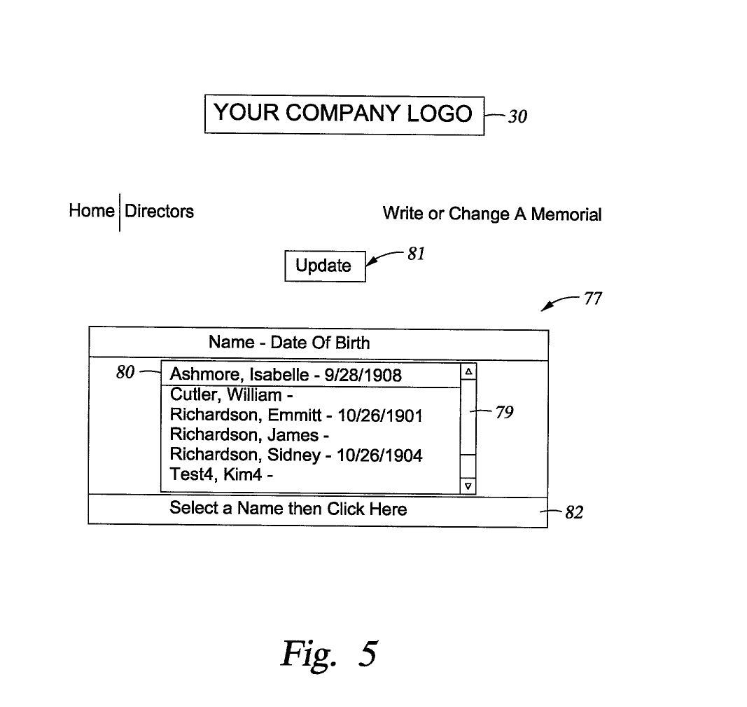

FIG. 5 is preferably the first screen page that is accessed when the “Write or Change A Memorial” hyperlink 34b from the Director's Page (FIG. 3) is clicked. This screen includes a “scroll box,” i.e., a window 77 with a scroll bar 79 for viewing the alphabetized names (located in a database) of all the individual memorial sites that have been established within a particular corporate web site. Using the scroll bar, the funeral director is able to scroll down to the name of the deceased individual from whom he wants to write a memorial. After highlighting the selected name 80 using the mouse, he can then either click the “Update” button 31, which provides editing access to the filled version of the “main memorial template,” or the “Select a Name then Click Here” button 82, which provides viewing access to the same filled main memorial template.

Once in this editing mode, the funeral director can create (and later edit) the on-line individual “memorial” for the deceased individual using an unfilled main memorial template, an example of which is shown in FIG. 6. In a specific embodiment, after the data is inputted and stored, a filled main memorial template can be generated, which is viewable and accessible (for editing) from the Director's Page (access to which requires the funeral director's confidential password) or from elsewhere by using the funeral director's confidential password. As discussed below, in another specific embodiment, some or all of the filled main memorial template can also be made viewable and accessible (for editing) from another protected page of the Memorial Site, e.g., from a page accessible to the family members using a family member password.

The main memorial page shown in FIG. 6 is an “assigned” page, wherein the “Sample Client” refers to the name of a deceased individual. The page includes Template 84, which has two columns. Template 84 is shown as a “filled” (partially filled) template which is available for editing. The field column 86 on the left side contains permanent “read only” data that describes each individual field. The Current Record column 88 on the right side has blank fields that can be filled by inputting information from a workstation, e.g., a keyboard. The Memorial For field 90 preferably contains the same text string as the name entered in the new record field corresponding to Enter Full Name 52 in FIG. 4, i.e., the name of the deceased. The Announcement Paragraph field 92 may contain the opening sentence of the memorial, i.e., an abbreviated version of what typically appears in a newspaper obituary. A History Paragraph field 94 is also provided, which contains a more detailed personal history of the deceased individual; this may also be included eventually in a newspaper obituary, but in certain versions of this invention, is not included in the newspaper because of the typically high cost of newspaper obituaries. In certain specific embodiments, additional “history” paragraph fields may be provided (not shown), e.g., a 1st History Paragraph field, a 2nd History Paragraph field and a 3rd History Paragraph field. Other fields may also be included, such as a “Proceeded in Death” field 100 which may contain the names of other relatives of the deceased who have died previously; a Survivors field 102 which may contain the names of surviving relatives of the deceased; a Funeral Information field 014 which may contain information regarding the funeral, e.g., referring to the church attendance of the deceased; and a Pallbearer Information field 106 which may contain the names of the pallbearers. It is understood, of course, that other terms may be used to describe these above-mentioned fields, and that other fields can be added as well. An “action” field 107 should also be provided, which includes a “return” button that returns the user to another screen, an “Update Current Record” button which returns the user to the first field (without deleting anything in the filled Template 84) and a “Reset” button which erases all the information inputting in the fields of Template 84.

Preferably, Template 84 is not only used to create the memorial by adding information to otherwise unfilled fields, but is also edited later, e.g., completed or changed. Such editing access to the template can be accomplished by clicking the “update” button in FIG. 5 (or a similar “update” button in a director's memorial viewing page or any other page that is protected, e.g., accessible only to the funeral director, e.g., from the Director's Page. Preferably, the director's update memorial template appears on the screen when the Update button 81 (FIG. 5) is clicked, after first highlighting the particular name 80 corresponding to the memorial. As discussed elsewhere herein, an advantage of the director's update memorial page feature is that the funeral director does not have to complete the memorial at one sitting. Rather, he can begin to create the on-line memorial from the corporate workstation, but leave it only partially completed. He can then return back at his convenience to update or edit the memorial at any time, without having to contact the web master, web host, or administrator of the web site or memorial site. In this way, he can work on it after normal working hours, or can delegate certain non-creative tasks (such as inputting basic personal information) to someone else, e.g., an funeral home employee who has the funeral director's confidential password. Then he (or someone else assigned with the task) can compose the contents of the memorial at a later time.

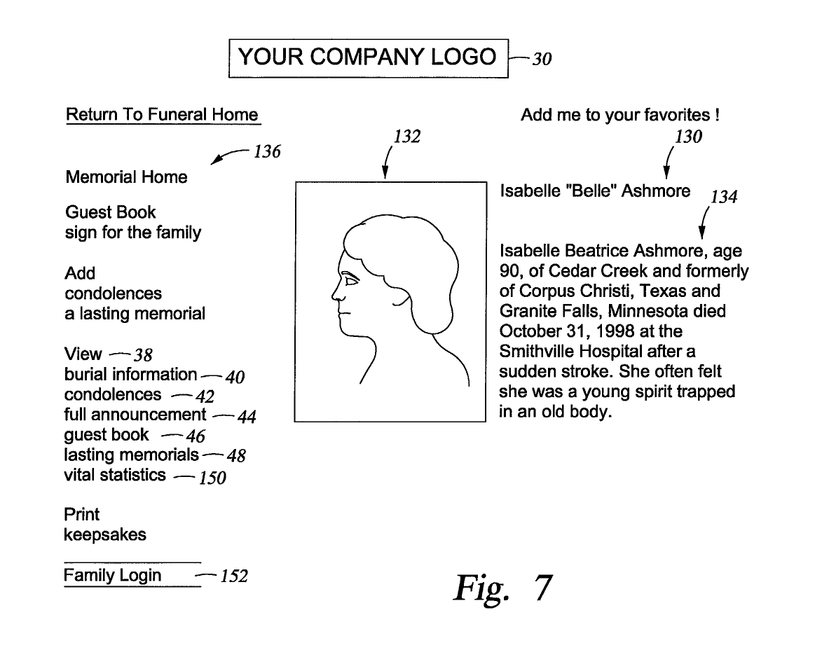

After template 84 has been filled initially (and optionally edited), the portions of the memorial site that are viewable by the general public have been created, as exemplified in FIG. 7, showing a completed public memorial site page (“displayed memorial”). This public memorial site page can be accessed for viewing by clicking a hyperlink located in another page on the main web site (not shown) corresponding to the name of the deceased. This public memorial site page preferably includes the name of the deceased 130, photograph 132 (if available) and announcement paragraph 134 (created using field 92 in template 84 in FIG. 6). This page also includes various hyperlinks associated with the memorial site, shown in the side menu 136 of FIG. 7.

Some of the hyperlinks merely provide viewing access to pages on the memorial site 10 corresponding to the hyperlinks, e.g., the “View” hyperlinks 138, which include the burial information hyperlink 140; “Condolences” hyperlink 142 (providing viewing access to a page written and transmitted to the family via a page that is accessible under the Condolences hyperlink under “Add”); the “Full Announcement” hyperlink 144 which provides a page with the complete memorial narrative, e.g., the contents of the History Paragraph created in template 84 (FIG. 6). Also included are the “Guest Book” hyperlink 146; the “Lasting Memorials” hyperlink 148 and the “Vital Statistics” hyperlink 150.

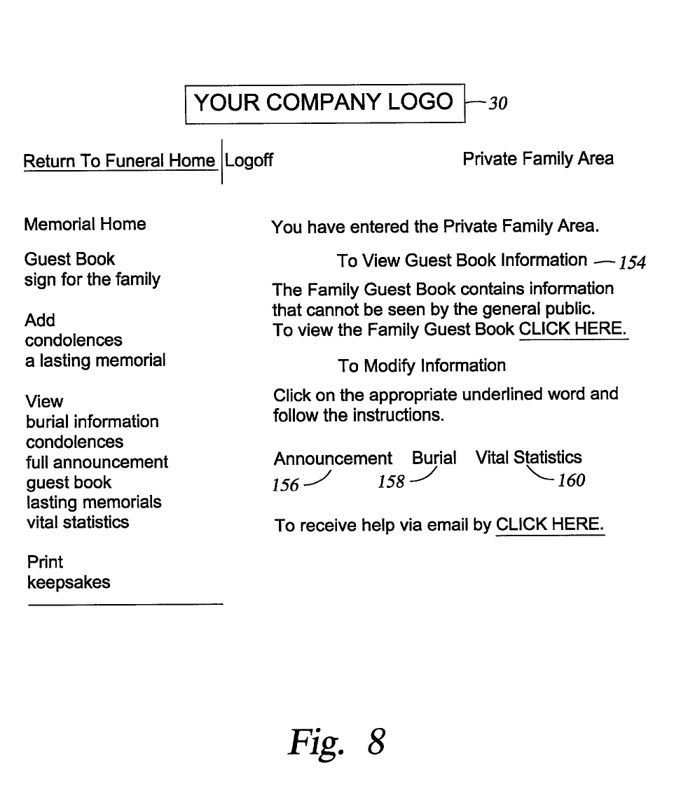

Another hyperlink is the Family Log-in hyperlink 152, which calls up a page (not shown) requesting the user to input the family password, which sends the user to the protected “Private Family Area” page, shown in FIG. 8. This page is similar to the Director's Page, in that it requires a confidential password to viewing access and provides viewing access (via hyper-links) to other pages which are viewable to only the family members and/or pages that include assigned templates enabling the family members to input (or edit) certain information on-line from the family workstation. As an example of the former, the “To View Guest Book Information” hyperlink 154 allows the family members to read the guest book, e.g., the list of persons attending the funeral. An example of the latter type of hyperlink includes a particularly advantageous feature of a preferred embodiment of this invention, which is the collection of “To Modify Information” hyperlinks, including the Announcement hyperlink 156, the Burial hyperlink 158 and the Vital Statistics hyperlink 160.

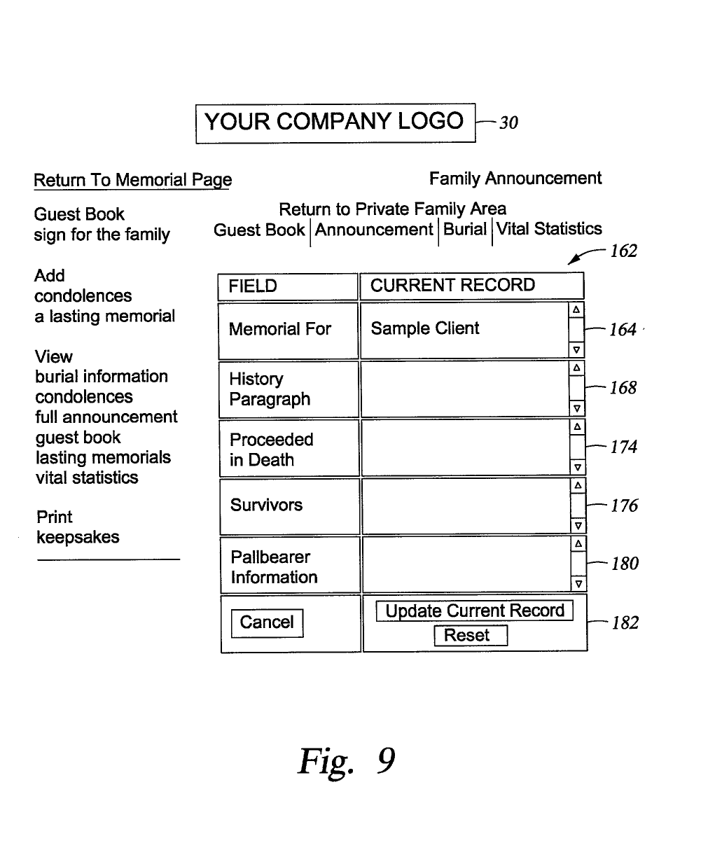

Clicking the Announcement hyperlink 156 in FIG. 8 causes the Family Announcement editing page shown in FIG. 9 to appear, which includes family editing template 162. Advantageously, most of the contents of the family editing template 162 (i.e., the filled-in fields) correspond to the information already inputted by the funeral director (shown in FIG. 6), e.g., including “Memorial for” field 164, History Paragraph field 168, Proceeded in Death field 174, Survivors field 176 and Pallbearers Information field 180. Also provided is an action field 182, which includes a Cancel button, a Reset button and an Update Current Record button, all having the same functionalities as the corresponding buttons in the funeral director's editing template 84 in FIG. 6. From the family workstation, the user can edit any of the information in the aforementioned fields and thus correct or modify information previously inputted by the funeral director. In this way, the memorial site can be referred to as an “interactive on-line memorial site.” In a specific embodiment, template 162 is the same as template 84, except that only certain fields are viewable and accessible for editing. Thus, the family members, using a family member password, have the same type of editing access to certain parts (fields) of the memorial template.

Either before or after the family member edits the announcement information using family editing template 162, the user can view the finished “family announcement” by referring to a family announcement viewing page (not shown), which provides viewing access to the “family announcement,” the contents of which should have been already inputted by the funeral director using template 84 in FIG. 6 and modified by the family using template 162. As discussed above, the “family announcement” is shown as part of FIG. 7. Advantageously, the family members can both view and edit the family announcement using a family workstation (e.g., from home) or other remote workstation, rather than having to view it and/or edit it from the funeral director's workstation. In this way, the family members can both “check” and edit the content of the announcement

What is claimed is:

1. A method of maintaining a memorial site on a funeral home web site, comprising: (a) providing for the posting without charge of a memorial page on a funeral home web site, the memorial page corresponding to a deceased individual, the memorial page including a photograph of the deceased individual and identifying text; (b) providing for a payment option symbol on the memorial page or on a different web page linked to the memorial page, such that the payment option symbol can be activated to provide one or more payments for maintaining the memorial page.

2. The method of claim 1 wherein the payment option symbol includes a hyperlink or a button directing the viewer to a payment page including one or more fields for inputting credit card information to provide payment for maintaining the memorial page.

3. The method of claim 1 wherein the payment option symbol is located on the memorial page and invites the viewer to pay to maintain the memorial page as a tribute to the deceased individual or as a gift to the family of the deceased.

4. The method of claim 1 wherein the different web page linked to the memorial page is a guest register page or a condolences page, by which a guest to the memorial page is able to (a) register his or her visit to the memorial page or transmit condolences to the family and (b) activate the payment option symbol.

5. The method of claim 1, additionally comprising receiving information relating to the deceased individual by facsimile and inputting some or all of the received information on the memorial page prior to posting the memorial page.

6. The method of claim 5 wherein the received information is transmitted by facsimile from the funeral home to an external location where the information is inputted and the memorial page is posted.

7. The method of claim 1 in which either (a) the funeral home posts the memorial page without charge or (b) an outside entity posts the memorial page for the funeral home without charge.

8. The method of claim 1 in which the identifying text includes the obituary of the deceased individual.

9. The method of claim 1 in which payment for maintaining the memorial page is made to an entity other than the funeral home.

10. A method of maintaining a memorial site on a funeral home website, comprising: (a) preparing a memorial site corresponding to a deceased individual; (b) posting the memorial site for viewing on a funeral home website for a first predetermined time period; (c) transmitting a request for payment to extend posting of the memorial site for a second predetermined time period beyond the first predetermined time period; and (d) extending the posting of the memorial site for the second predetermined time period.

11. A method of maintaining a funeral home website, comprising: (a) posting a memorial site for on-line viewing on the funeral home website; (b) transmitting a request for payment after the memorial site is posted; (c) deactivating the memorial site in the event payment is not received; and (d) extending the posting of the memorial site in the event payment is received.

12. A method of maintaining a funeral home website, comprising: (a) posting a first memorial site corresponding to a deceased individual for on-line viewing of the first memorial site on the funeral home website; (b) transmitting a request for payment after the first memorial site is posted but not before the first memorial site is posted; (c) posting a second memorial site corresponding to the same deceased individual in the event the requested payment is received, wherein the second memorial site has either substantially the same or additional content as the first memorial site; and (d) deactivating the first memorial site in the event the requested payment is not received.

13. The method of claim 10 wherein the memorial site is posted on the funeral home website for the first predetermined period of time at no charge to the family of the deceased individual.

14. The method of claim 10 wherein the memorial site posted on the funeral home website for the first predetermined period of time includes a narrative containing a personal history of the deceased individual and at least one photograph.

15. The method of claim 14 wherein the narrative containing a personal history of the deceased individual is more extensive than the personal history contained in that individual's newspaper obituary.

16. The method of claim 10, wherein the memorial site posted on the funeral home website for the first predetermined period of time includes two or more photographs that include the deceased individual.

17. The method of claim 10, wherein the request for payment is transmitted via email.

18. The method of claim 10, wherein the request for payment is transmitted via email to a user entering his or her name on the Guest Book.

19. The method of claim 10, wherein the request for payment is transmitted via email to a user entering information using the Condolences field.

20. The method of claim 10, wherein the request for payment is transmitted via email to a Family Member.

21. The method of claim 10, wherein the memorial site is deactivated after the predetermined time period in the absence of payment.

22. The method of claim 10, additionally comprising the step of receiving payment.

23. The method of claim 22, wherein payment is received electronically.

24. The method of claim 22, wherein payment is received by transmission of credit card information.

25. The method of claim 10, wherein the memorial site is deactivated after the first predetermined time period in the absence of payment, additionally comprising providing data symbolic of time remaining for the memorial site to be deactivated.

26. The method of claim 25 wherein the data symbolic of time remaining for the memorial site to be deactivated includes a number representing the days left before the memorial site is to be deactivated or a number representing the date the memorial site is to be deactivated.

27. The method of claim 25 wherein the providing of data symbolic of time remaining for the memorial site to be deactivated is maintained automatically.

28. The method of claim 27 wherein the providing of data symbolic of time remaining for the memorial site to be deactivated is maintained by a system that includes a time clock.

29. The method of claim 10, wherein the first predetermined time period is 30 days, 60 days, or 90 days.
